(19) United States
(12) Patent Application Publication
(10) Pub. No.: US 2025/0004111 A1
(43) Pub. Date: Jan. 2, 2025

(54) LIGHT DETECTION ELEMENT

(71) Applicant: SONY SEMICONDUCTOR SOLUTIONS CORPORATION, KANAGAWA (JP)

(72) Inventors: YASUNORI TSUKUDA, KANAGAWA (JP); KAZUTOSHI TOMITA, KANAGAWA (JP); HIDEKI OZAWA, KANAGAWA (JP)

(21) Appl. No.: 18/708,084

(22) PCT Filed: Oct. 31, 2022
(86) PCT No.: PCT/JP2022/040608

§ 371 Date: May 7, 2024

(30) Foreign Application Priority Data
Nov. 15, 2021 (JP) 2021-185563

(51) Int. Cl. G01S 7/4865; G01S 17/10; G01S 17/931

(52) U.S. Cl. CPC G01S 7/4865; G01S 17/10; G01S 17/931

(57) ABSTRACT

Power consumption is reduced. A light detection element (2) includes: a pixel (100) including a light receiving element (101) that receives reflected light obtained by reflecting emission light emitted from a light source device by a target object, and generates a light reception signal based on reception of the reflected light; a reflected light signal generation section (210) that generates a reflected light signal that is a signal having a predetermined pulse width on the basis of the light reception signal; a time code generation section (200) that generates a time code that is a time-series code according to an elapsed time from emission of the emission light for each specific cycle; and a time code holding section (260) that includes a latch circuit (D latch 221) that has a data input terminal to which the time code generated is input and an enable terminal to which the reflected light signal is input and holds the time code input, outputs the time code input from an output terminal during a period in which the reflected light signal is input, and holds the time code input when input of the reflected light signal is stopped.

### FIELD

The present disclosure relates to a light detection element.

### BACKGROUND

As a distance measuring device that measures a distance to a target object, a distance measuring device based on a time of flight (ToF) method is used. The ToF method is a method of measuring a distance to a target object by irradiating the target object with light to receive reflected light and measuring a time-of-flight of the light. A time to digital converter (TDC) can be used to measure the time-of-flight. The TDC converts the elapsed time into a digital signal. In the TDC, time-series codes are sequentially generated from the start of light irradiation to the target object, and the codes generated at the time of receiving the reflected light are captured. The time-of-flight of the light can be detected by outputting a digital signal of the elapsed time corresponding to the captured code. As such a TDC, there has been proposed a TDC that captures a time-series code (counting signal) and causes a holding section including a D flip-flop to hold the code (see, for example, Patent Literature 1).

### CITATION LIST

### Patent Literature

Patent Literature 1: JP 2020-197457 A

### SUMMARY

### Technical Problem

However, the above-described conventional technique has a problem that power consumption increases. A time-series counting signal is input to the data input of the D flip-flop of the holding section described above. Every time this counting signal changes, the circuit inside the D flip-flop toggles. For this reason, there is a problem that the power consumption during the period of counting the time-of-flight increases.

Therefore, the present disclosure proposes a light detection element that reduces power consumption.

### Solution to Problem

A light detection element according to the present disclosure includes: a pixel including a light receiving element that receives reflected light obtained by reflecting emission light emitted from a light source device by a target object, and generates a light reception signal based on reception of the reflected light; a reflected light signal generation section that generates a reflected light signal that is a signal having a predetermined pulse width on the basis of the light reception signal; a time code generation section that generates a time code that is a time-series code according to an elapsed time from emission of the emission light for each specific cycle; and a time code holding section that includes a latch circuit that has a data input terminal to which the time code generated is input and an enable terminal to which the reflected light signal is input and holds the time code input, outputs the time code input from an output terminal during a period in which the reflected light signal is input, and holds the time code input when input of the reflected light signal is stopped.

### BRIEF DESCRIPTION OF DRAWINGS

FIG. 1 is a diagram illustrating a configuration example of a distance measuring device according to an embodiment of the present disclosure.

FIG. 2 is a diagram illustrating a configuration example of a distance measuring section according to a first embodiment of the present disclosure.

FIG. 3 is a diagram illustrating a configuration example of a pixel according to the first embodiment of the present disclosure.

FIG. 4 is a diagram illustrating a configuration example of a reflected light signal generation section according to the first embodiment of the present disclosure.

FIG. 5 is a diagram illustrating a configuration example of a time code generation section according to the first embodiment of the present disclosure.

FIG. 6 is a diagram illustrating an example of a time code according to an embodiment of the present disclosure.

FIG. 7 is a diagram illustrating a configuration example of a time code holding section according to the first embodiment of the present disclosure.

FIG. 8 is a diagram illustrating a configuration example of a time code conversion section according to the first embodiment of the present disclosure.

FIG. 9 is a diagram illustrating a configuration example of a histogram generation section according to the first embodiment of the present disclosure.

FIG. 10 is a diagram illustrating an example of generation of a histogram according to the first embodiment of the present disclosure.

FIG. 11A is a diagram illustrating a configuration example of a latch circuit according to an embodiment of the present disclosure.

FIG. 11B is a diagram illustrating a configuration example of a D flip-flop circuit.

FIG. 12 is a diagram illustrating a configuration example of a distance measuring section according to a second embodiment of the present disclosure.

FIG. 13A is a diagram illustrating a configuration example of a control section according to the second embodiment of the present disclosure.

FIG. 13B is a diagram illustrating transition of states of a control section according to the second embodiment of the present disclosure.

FIG. 14 is a diagram illustrating a configuration example of a time code selection section according to the second embodiment of the present disclosure.

FIG. 15 is a diagram illustrating an example of generation of a histogram according to the second embodiment of the present disclosure.

FIG. 16 is a diagram illustrating another configuration example of the distance measuring section according to the second embodiment of the present disclosure.

FIG. 17 is a diagram illustrating another example of generation of a histogram according to the second embodiment of the present disclosure.

FIG. 18 is a diagram illustrating a configuration example of a distance measuring section according to a third embodiment of the present disclosure.

FIG. 19 is a diagram illustrating a configuration example of a time code holding section according to the third embodiment of the present disclosure.

FIG. 20 is a diagram illustrating a configuration example of a histogram selection section according to the third embodiment of the present disclosure.

FIG. 21 is a diagram illustrating an example of generation of a histogram according to the third embodiment of the present disclosure.

FIG. 22 is a diagram illustrating a configuration example of a histogram selection section according to a fourth embodiment of the present disclosure.

FIG. 23 is a diagram illustrating an example of generation of a histogram according to the fourth embodiment of the present disclosure.

FIG. 24 is a diagram illustrating a configuration example of a distance measuring section according to a fifth embodiment of the present disclosure.

FIG. 25 is a diagram illustrating a configuration example of a distance measuring section according to a sixth embodiment of the present disclosure.

FIG. 26 is a diagram illustrating an example of adjustment of time codes according to the sixth embodiment of the present disclosure.

FIG. 27 is a diagram illustrating a configuration example of a histogram correction section according to the sixth embodiment of the present disclosure.

FIG. 28 is a diagram illustrating an example of histogram correction according to the sixth embodiment of the present disclosure.

FIG. 29 is a diagram illustrating another configuration example of the distance measuring section according to the sixth embodiment of the present disclosure.

FIG. 30 is a diagram illustrating a configuration example of an identification signal correction section according to the sixth embodiment of the present disclosure.

FIG. 31 is a diagram illustrating a configuration example of an identification signal correction section according to the sixth embodiment of the present disclosure.

FIG. 32 is a diagram illustrating another example of the generation of the histogram according to the sixth embodiment of the present disclosure.

FIG. 33 is a diagram illustrating another configuration example of the reflected light signal generation section according to an embodiment of the present disclosure.

FIG. 34 is a diagram illustrating another configuration example of the reflected light signal generation section according to an embodiment of the present disclosure.

FIG. 35 is a diagram illustrating another configuration example of the reflected light signal generation section according to an embodiment of the present disclosure.

FIG. 36A is a diagram illustrating another configuration example of the pixel array section and the reflected light signal generation section according to an embodiment of the present disclosure.

FIG. 36B is a diagram illustrating another configuration example of the pixel array section and the reflected light signal generation section according to an embodiment of the present disclosure.

FIG. 37 is a diagram illustrating another configuration example of the reflected light signal generation section according to an embodiment of the present disclosure.

FIG. 38A is a plan view illustrating a configuration example of a light detection element according to an embodiment of the present disclosure.

FIG. 38B is a plan view illustrating a configuration example of a distance measuring device according to an embodiment of the present disclosure.

FIG. 39A is a plan view illustrating another example of the configuration of the light detection element according to an embodiment of the present disclosure.

FIG. 39B is a plan view illustrating another example of the configuration of the distance measuring device according to an embodiment of the present disclosure.

FIG. 40 is a plan view illustrating another example of the configuration of the light detection element according to an embodiment of the present disclosure.

FIG. 41 is a plan view illustrating another example of the configuration of the distance measuring device according to an embodiment of the present disclosure.

FIG. 42 is a plan view illustrating another example of the configuration of the light detection element according to an embodiment of the present disclosure.

FIG. 43 is a plan view illustrating another example of the configuration of the distance measuring device according to an embodiment of the present disclosure.

FIG. 44 is a plan view illustrating another example of the configuration of the light detection element according to an embodiment of the present disclosure.

FIG. 45 is a plan view illustrating another example of the configuration of the distance measuring device according to an embodiment of the present disclosure.

FIG. 46 is a block diagram depicting an example of schematic configuration of a vehicle control system.

FIG. 47 is a diagram of assistance in explaining an example of installation positions of an outside-vehicle information detecting section and an imaging section.

### DESCRIPTION OF EMBODIMENTS

Hereinafter, embodiments of the present disclosure will be described in detail with reference to the drawings. The description will be given in the following order. Note that, in each of the following embodiments, the same parts are denoted by the same reference signs, and redundant description will be omitted.
1. First Embodiment
2. Second Embodiment
3. Third Embodiment
4. Fourth Embodiment
5. Fifth Embodiment
6. Sixth Embodiment
7. Configuration of Reflected Light Signal Generation Section
8. Configuration of Distance Measuring Device
9. Application Example to Mobile Body

### 1. First Embodiment

### [Configuration of Distance Measuring Device]

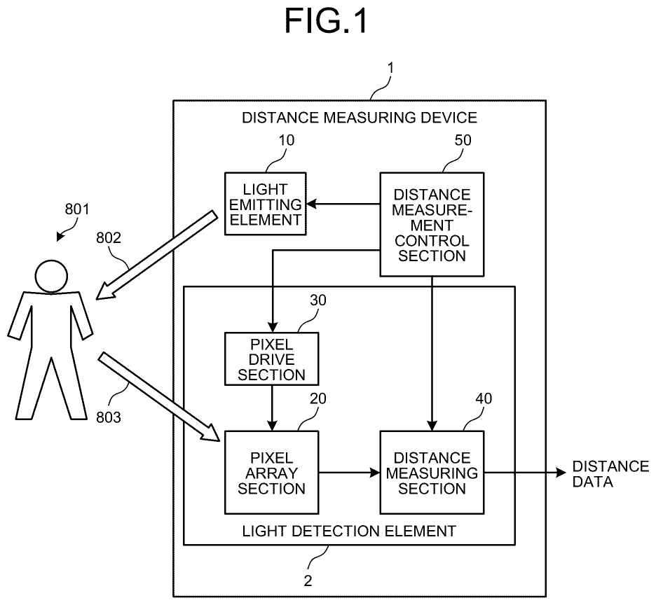

FIG. 1 is a diagram illustrating a configuration example of a distance measuring device according to an embodiment of the present disclosure. The drawing is a block diagram illustrating a configuration example of a distance measuring device 1. The distance measuring device 1 measures a distance to a target object by measuring a time-of-flight of light with the target object. The distance measuring device 1 in the drawing illustrates an example in which an emission light 802 is emitted to a target object 801, a reflected light 803 obtained by reflecting the emission light 802 by the target object 801 is detected, and the distance to the target object 801 is detected by measuring the time-of-flight from the emission of the emission light 802 to the detection of the reflected light 803. The distance measuring device 1 includes a light emitting element 10, a pixel array section 20, a pixel drive section 30, a distance measuring section 40, and a distance measurement control section 50. Note that the pixel drive section 30, the pixel array section 20, and the distance measuring section 40 in the drawing constitute a light detection element 2.

The light emitting element 10 emits the emission light 802. The light emitting element 10 includes, for example, a laser diode, and is driven by the distance measurement control section 50 to emit pulsed emission light.

The pixel array section 20 includes a pixel (pixel 100 to be described later) that receives the reflected light 803 obtained by the emission light 802 from the light emitting element 10 being reflected by the target object 801, and generates a light reception signal. The configuration of the pixel 100 will be described later.

The pixel drive section 30 drives the pixel 100 of the pixel array section 20. The pixel drive section 30 generates and outputs a control signal of the pixel 100 on the basis of the control of the distance measurement control section 50.

The distance measuring section 40 detects the time-of-flight on the basis of the light reception signal. The distance measuring section 40 measures the time-of-flight from the emission of the emission light 802 to the input of the light reception signal on the basis of the control of the distance measurement control section 50. Furthermore, the distance measuring section 40 outputs data of the measured time-of-flight as distance data. For this time-of-flight data, for example, a histogram of the time-of-flight representing the time-of-flight as a frequency can be applied.

The distance measurement control section 50 controls the entire distance measuring device 1. Furthermore, the distance measurement control section 50 drives the light emitting element 10 and outputs a notification of the emission of the emission light 802 to the distance measuring section 40. The distance measuring section 40 starts measuring the time-of-flight in response to the notification of the emission. Details of the configuration of the distance measuring section 40 will be described later.

### [Configuration of Distance Measuring Section]

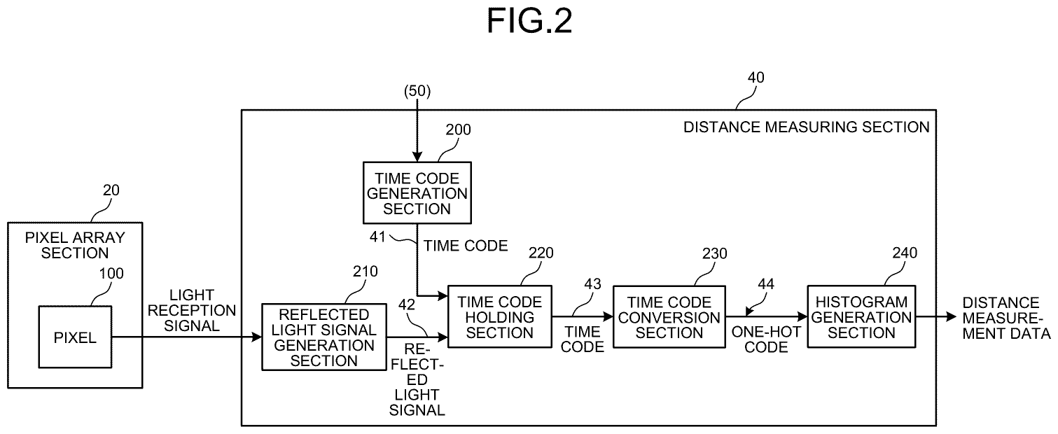

FIG. 2 is a diagram illustrating a configuration example of a distance measuring section according to the first embodiment of the present disclosure. The drawing is a block diagram illustrating a configuration example of the distance measuring section 40. Note that the pixel array section 20 and the pixel 100 are further described in the drawing. The distance measuring section 40 includes a time code generation section 200, a reflected light signal generation section 210, a time code holding section 220, a time code conversion section 230, and a histogram generation section 240.

The time code generation section 200 generates a time code and outputs the time code to the time code holding section 220. Here, the time code is a time-series code and is a code representing an elapsed time from the emission of the emission light from the light emitting element 10. The time code generation section 200 in the drawing starts generation of the time code on the basis of the notification of emission from the distance measurement control section 50. For example, a binary code or a gray code whose value sequentially increases can be applied to the time code. Hereinafter, a time code based on a gray code is assumed. The time code generation section 200 generates a time code in a constant cycle. The cycle of generating the time code is referred to as a specific cycle. This specific cycle corresponds to a unit time of time-of-flight detection, and corresponds to a width of a class of a histogram of time-of-flight described later.

The reflected light signal generation section 210 generates a reflected light signal on the basis of the light reception signal output from the pixel 100. The reflected light signal is a signal having a predetermined pulse width based on the light reception signal. The generated reflected light signal is output to the time code holding section 220.

The time code holding section 220 captures and holds the time code output from the time code generation section 200. The time code holding section 220 captures the time code on the basis of the reflected light signal from the reflected light signal generation section 210. In addition, the time code holding section 220 outputs the held time code to the time code conversion section 230. Details of the configuration of the time code holding section 220 will be described later.

The time code conversion section 230 converts the time code output from the time code holding section 220 into a so-called one-hot code. The one-hot code will be described later. The time code conversion section 230 outputs the one-hot code to the histogram generation section 240.

The histogram generation section 240 generates a histogram of the time-of-flight. The histogram of the time-of-flight is a histogram representing the detection frequency of the time-of-flight as a frequency for each class of the width of the specific cycle. The histogram generation section 240 in the drawing creates a histogram on the basis of the one-hot code output from the time code conversion section 230. The generated histogram of the time-of-flight is output to an external device as distance measurement data.

### [Configuration of Pixel]

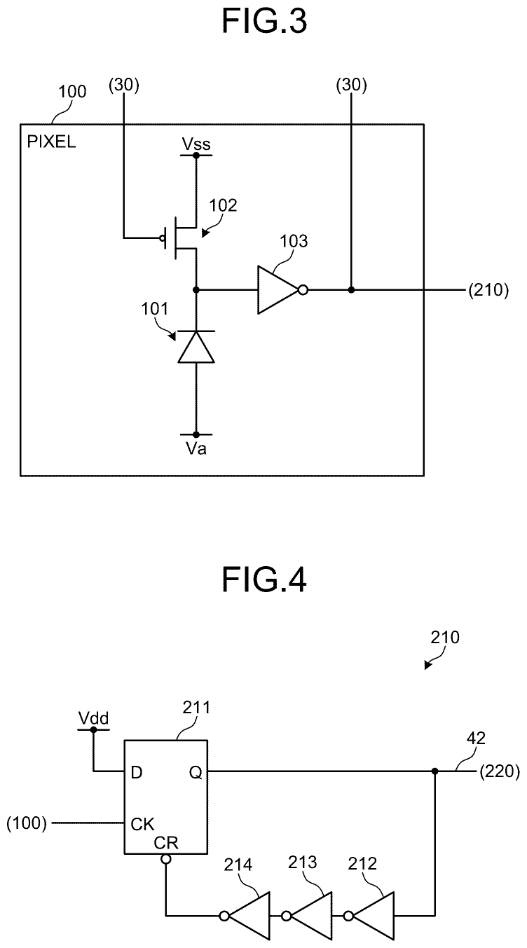

FIG. 3 is a diagram illustrating a configuration example of a pixel according to the first embodiment of the present disclosure. The drawing is a circuit diagram illustrating a configuration example of the pixel 100. The pixel 100 in the drawing includes a light receiving element 101, a MOS transistor 102, and a buffer amplifier 103.

The light receiving element 101 is a semiconductor element that receives light. An avalanche photo diode (APD) can be used as the light receiving element 101. The APD is a light receiving diode that operates in a state where a reverse bias voltage is applied. By setting the reverse bias voltage to a voltage near the breakdown voltage, a high electric field is formed in the depletion layer inside the APD. By the avalanche multiplication action by the high electric field, the APD can increase the charge generated by the photoelectric conversion of the incident light, and can improve the light receiving sensitivity. The anode of the light receiving element 101 is connected to the bias voltage Va of the negative polarity, and the cathode is connected to the drain of the MOS transistor 102 and the input of the buffer amplifier 103.

In addition, a single photon avalanche diode (SPAD) can also be used for the light receiving element 101. The SPAD is an APD in which a charge multiplication action is improved by applying a reverse bias voltage exceeding a breakdown voltage. In the SPAD, a charge generated by photoelectric conversion rapidly increases due to a high multiplication action. Due to this increased charge, a steeply rising current flows through the SPAD. By detecting this current and generating a pulse signal, incidence of a single photon can be detected. Such an operation mode is referred to as a Geiger mode. Hereinafter, the SPAD is assumed as the light receiving element.

The MOS transistor 102 applies a power supply voltage to the cathode of the light receiving element 101. The MOS transistor 102 operates as a constant current source on the basis of the control of the pixel drive section 30, and charges the cathode of the light receiving element 101 to a power supply voltage.

The buffer amplifier 103 amplifies a signal generated by the light receiving element 101 and outputs the amplified signal as a light reception signal. The light reception signal is output to the pixel drive section 30 and the reflected light signal generation section 210.

When the light receiving element 101 receives light, the light receiving element 101 is brought into a conductive state. The cathode of the light receiving element 101 charged by the MOS transistor 102 is rapidly discharged and decreases to the bias voltage Va. Therefore, the light receiving element 101 returns to the non-conductive state, and the cathode of the light receiving element 101 is charged again. As described above, when light enters the light receiving element 101, a pulsed signal is generated at the cathode of the light receiving element 101. The buffer amplifier 103 amplifies this signal to generate and output a light reception signal.

### [Configuration of Reflected Light Signal Generation Section]

FIG. 4 is a diagram illustrating a configuration example of a reflected light signal generation section according to the first embodiment of the present disclosure. The drawing is a circuit diagram illustrating a configuration example of the reflected light signal generation section 210. The reflected light signal generation section 210 in the drawing includes a D flip-flop 211 and NOT gates 212 to 214. A data input terminal of the D flip-flop 211 is connected to a power supply line, and a clock terminal is connected to an output of the pixel 100. A Q output of the D flip-flop 211 is connected to inputs of the signal line 42 and the NOT gate 212. An output of the NOT gate 212 is connected to an input of the NOT gate 213, and an output of the NOT gate 213 is connected to an input of the NOT gate 214. The output of the NOT gate 214 is connected to the clear terminal of the D flip-flop 211.

A light reception signal is input to a data input terminal of the D flip-flop 211. The Q output transitions to the value “1” in synchronization with the rising of the light reception signal. The change in the voltage of the Q output is input to the clear input of the D flip-flop 211 via the circuits of the NOT gates 212 to 214 connected in series. As a result, the Q output of the D flip-flop 211 transitions to the value “0”. As described above, a signal having a pulse width corresponding to the delay time by the circuits of the NOT gates 212 to 214 connected in series is generated. A signal based on the light reception signal is referred to as a reflected light signal. Note that the circuits of the NOT gates 212 to 214 connected in series are an example of a signal delay section described in the claims.

### [Configuration of Time Code Generation Section]

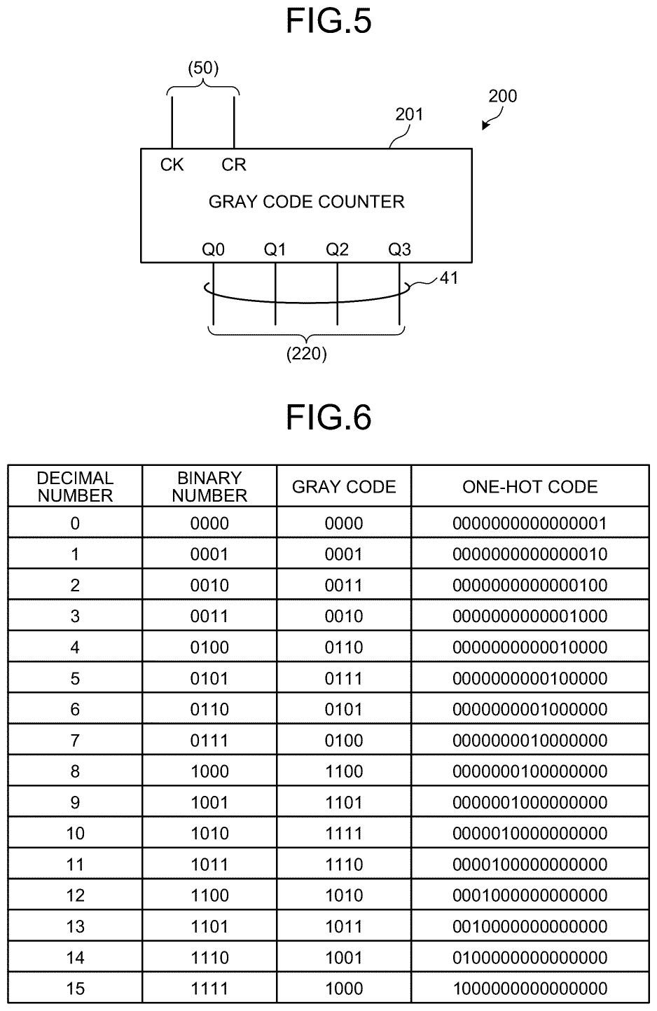

FIG. 5 is a diagram illustrating a configuration example of a time code generation section according to the first embodiment of the present disclosure. The drawing is a diagram illustrating a configuration example of the time code generation section 200. The time code generation section 200 in the drawing includes a gray code counter 201. Note that, in the time code generation section 200 in the drawing, a 4-bit time code is assumed.

The gray code counter 201 is a counter that generates a gray code. The gray code counter 201 counts gray codes on the basis of the clear signal and the clock signal input from the distance measurement control section 50 to generate time-series gray codes. The generated gray code is output from the outputs Q0 to Q3 to the signal line 41. Note that, in a case where the binary code is applied to the time code, a binary counter is arranged instead of the gray code counter 201. Note that the cycle of the clock signal coincides with the specific cycle.

Note that the time code is not limited to this example. For example, a one-hot code can be used as the time code. In addition, the bit width of the time code can also be changed.

### [Configuration of Time Code]

FIG. 6 is a diagram illustrating an example of a time code according to an embodiment of the present disclosure. The drawing is a diagram illustrating an example of gray codes that can be used as time codes. “Decimal number” in the drawing represents a decimal number between 0 and 15. “Binary number” and “gray code” in the drawing describe notations of a binary number and a gray code corresponding to a decimal number. Note that “binary number” in the drawing is equivalent to a binary code. As illustrated in the drawing, the gray code is a code that changes by one bit between adjacent codes. A time code in a state of 16 can be configured by a 4-bit binary code and a gray code. Note that a one-hot code is also described in the drawing. As illustrated in the drawing, the one-hot code is a code having the number of bits having a width equal to the number of states to be expressed, and is a code in which bits having a value “1” sequentially move between adjacent codes.

### [Configuration of Time Code Holding Section]

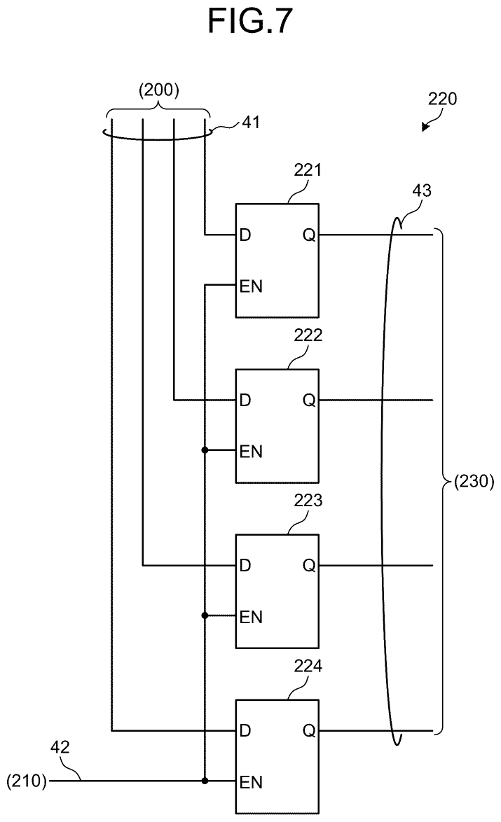

FIG. 7 is a diagram illustrating a configuration example of a time code holding section according to the first embodiment of the present disclosure. The drawing is a diagram illustrating a configuration example of the time code holding section 220. The time code holding section 220 in the drawing includes D latches 221 to 224. One of the signal lines 41 is wired to the data input terminals of the D latches 221 to 224. A signal line 42 is commonly connected to enable terminals of the D latches 221 to 224. One of the four signal lines 43 is connected to the Q output terminals of the D latches 221 to 224. Note that the D latches 221 to 224 are an example of a latch circuit described in the claims.

The time code from the time code generation section 200 is input to the data input terminals of the D latches 221 to 224. Furthermore, the reflected light signal from the reflected light signal generation section 210 is input to the enable input terminals of the D latches 221 to 224. In the D latches 221 to 224, a time code input to the data input terminal in a period in which the reflected light signal having the value “1” is input to the enable terminal is output to the Q output. Thereafter, when the reflected light signal input to the enable terminal transitions to the value “0”, the D latches 221 to 224 hold the time code in an internal holding circuit and output the held time code.

### [Configuration of Time Code Conversion Section]

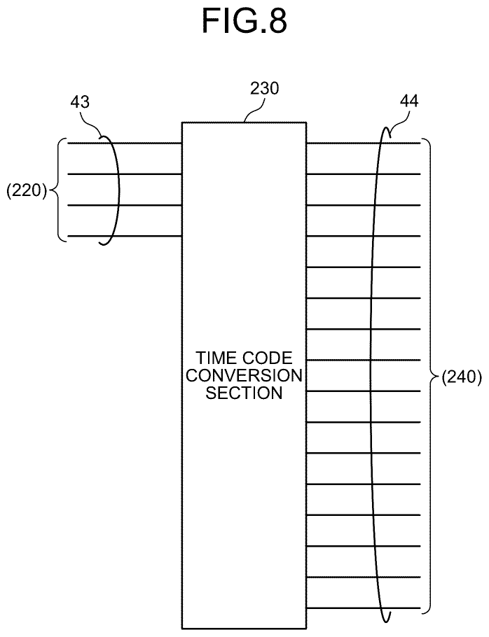

FIG. 8 is a diagram illustrating a configuration example of a time code conversion section according to the first embodiment of the present disclosure. The drawing is a diagram illustrating a configuration example of the time code conversion section 230. The time code conversion section 230 in the drawing converts a time code including a 4-bit gray code into a 16-bit one-hot code. Note that the relationship between the gray code and the one-hot code after conversion is as described in FIG. 6.

### [Configuration of Histogram Generation Section]

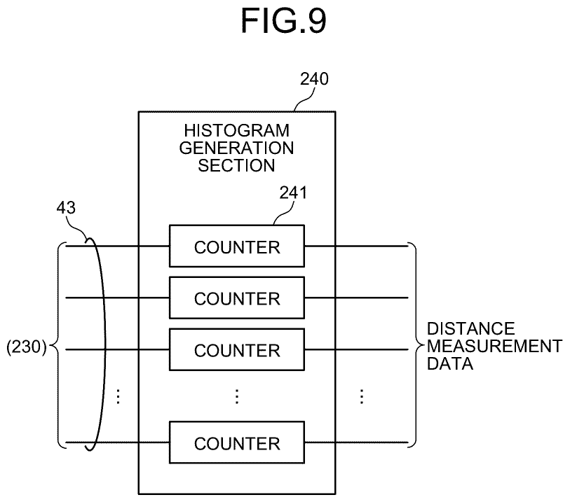

FIG. 9 is a diagram illustrating a configuration example of a histogram generation section according to the first embodiment of the present disclosure. The drawing is a diagram illustrating a configuration example of the histogram generation section 240. The histogram generation section 240 in the drawing includes a plurality of counters 241. The plurality of counters 241 corresponds to respective classes of the histogram. Count values of the plurality of counters 241 correspond to the frequency of each class. One-hot codes corresponding to time codes are input to the plurality of counters 241. The counter 241 to which the value “1” in the one-hot code is input adds the value “1” to its own count value and updates the count value. As a result, a histogram of the time-of-flight can be generated. In addition, by sequentially outputting the count values of the plurality of counters 241, a histogram of the time-of-flight can be output as distance measurement data.

### [Generation of Histogram]

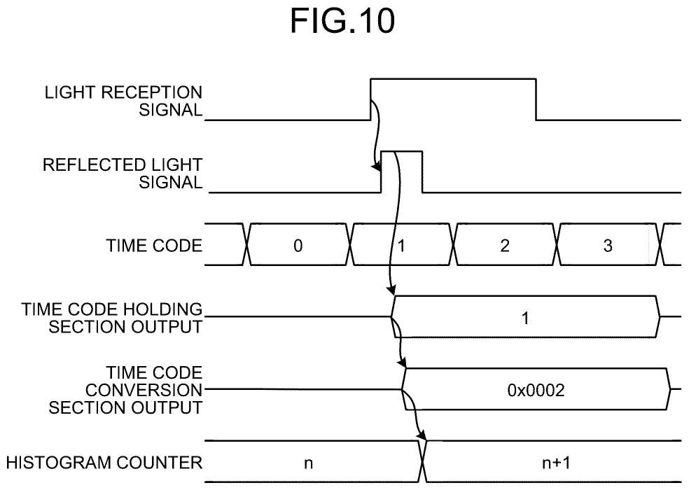

FIG. 10 is a diagram illustrating an example of generation of a histogram according to the first embodiment of the present disclosure; The drawing is a timing chart illustrating an example of generation of a histogram of time-of-flights in the distance measuring section 40. “Light reception signal”, “reflected light signal”, and “time code” in the drawing represent the light reception signal output from the pixel 100, the reflected light signal output from the reflected light signal generation section 210, and the time code output from the time code generation section 200, respectively. Further, “time code holding section output” and “time code conversion section output” represent the time code output from the time code holding section 220 and the one-hot code output from the time code conversion section 230, respectively. In addition, “histogram counter” represents the count value of the counter 241 of the histogram generation section 240. Note that the time code in the drawing is expressed in a decimal number. In addition, the one-hot code in the drawing is expressed in 16 digits.

When the reflected light is incident on the light receiving element 101 of the pixel 100, a light reception signal having an arbitrary pulse width is generated and input to the reflected light signal generation section 210. A reflected light signal having a predetermined pulse width is generated on the basis of the light reception signal. As described above, the reflected light signal is a signal having a pulse width corresponding to the delay time of the delay section, and is a signal having a substantially constant pulse width. The time code when the reflected light signal is input is taken into the time code holding section 220, output, and held. In the drawing, an example is illustrated in which the time code of the value “1” is captured and output in the time code holding section 220. This time code is converted into a one-hot code having a value “0x0002” by the time code conversion section 230 and input to the histogram generation section 240. The counter 241 corresponding to the one-hot code updates the count value from n to n+1. By repeating such processing, a histogram of the time-of-flight can be generated.

### [Configuration of Latch Circuit]

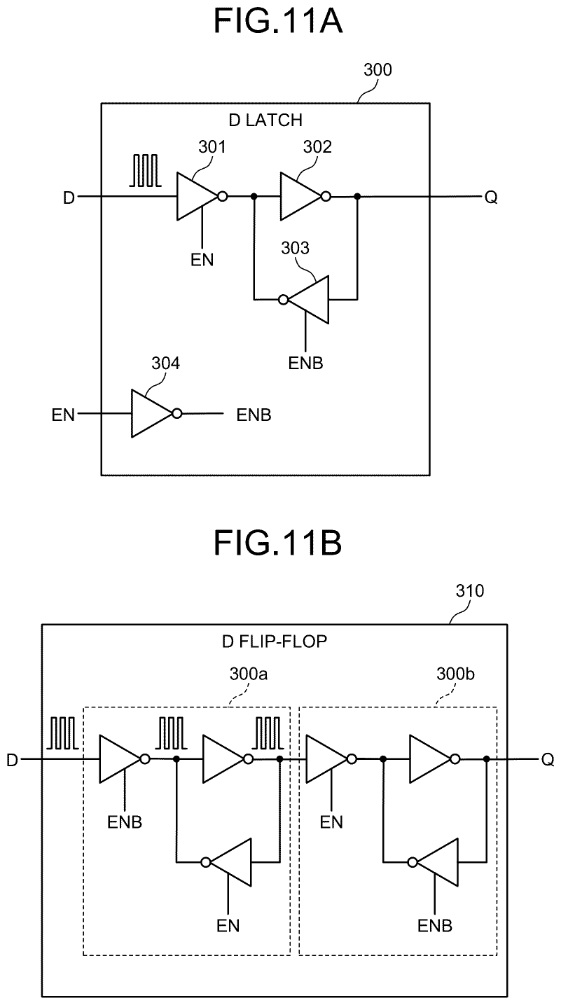

FIG. 11A is a diagram illustrating a configuration example of a latch circuit according to an embodiment of the present disclosure. The drawing is a circuit diagram illustrating a configuration example of a D latch 300 applicable to the time code holding section 220. The D latch 300 in the drawing includes NOT gates 301 to 304. Note that NOT gates with a control terminal can be used as the NOT gates 301 and 303. The data input terminal is connected to an input of the NOT gate 301. The output of the NOT gate 301 and the input of the NOT gate 303 are commonly connected to the input of the NOT gate 302. The output of the NOT gate 302 is connected to the Q output. Note that the NOT gate 304 inverts the enable signal and outputs the inverted enable signal to the node ENB. An enable signal is input to the node EN in the drawing.

The NOT gates 302 and 303 in the drawing constitute a holding circuit. When the enable signal is input, the NOT gate 301 conducts, inverts the signal of the data input, and transmits the inverted signal to the holding circuit. When the input of the enable signal is stopped, the NOT gate 301 transitions to the non-conductive state, the NOT gate 303 is conductive, and the signal of the data input input to the NOT gate 302 is held.

In the D latch 221 of the time code holding section 220 described above, the reflected light signal is input as an enable signal, and the time code is input to the data input terminal. This time code is also input to the data input terminal during a period in which the reflected light signal is not input. The signal waveform in the drawing illustrates this state. However, during this period, the NOT gate 301 becomes non-conductive, and thus is not transmitted to the internal circuit. Since only the input of the NOT gate 301 is toggled by the time code, the power consumption of the D latch 300 can be reduced.

FIG. 11B is a diagram illustrating a configuration example of a D flip-flop circuit. The drawing is a circuit diagram illustrating a configuration example of a D flip-flop 310 illustrated as a comparative example. The D flip-flop 310 in the drawing includes D latches 300a and 300b connected in cascade. Note that, in the D latches 300a and 300b, the connection between the node EN and the node ENB is reversed.

As illustrated in the drawing, the node ENB is connected to the NOT gate 301 of the D latch 300a in the previous stage. Therefore, the NOT gate 301 is brought into a conductive state during a period in which the reflected light signal is not input, and the range toggled by the input of the time code extends to the output of the D latch 300a. In a case where the D flip-flop 310 is used for the time code holding section 220, power consumption increases.

As described above, the distance measuring device 1 according to the first embodiment of the present disclosure can reduce power consumption by arranging the D latch 221 and the like in the time code holding section 220.

### 2. Second Embodiment

The distance measuring device 1 of the first embodiment described above uses the time code holding section 220. On the other hand, a distance measuring device 1 according to a second embodiment of the present disclosure is different from the above-described first embodiment in that a plurality of time code holding sections is used.

### [Configuration of Distance Measuring Section]

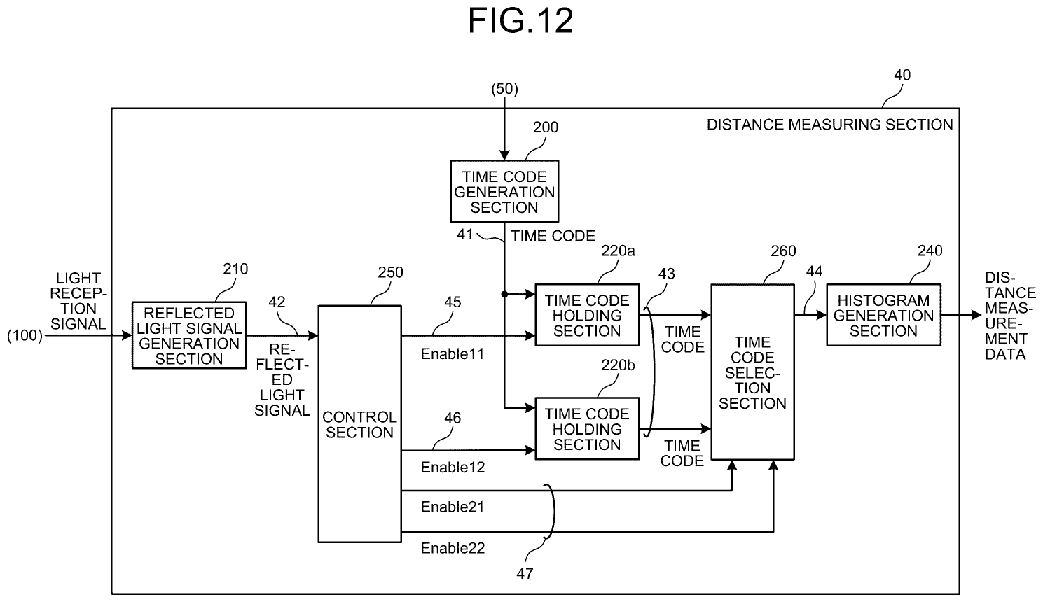

FIG. 12 is a diagram illustrating a configuration example of a distance measuring section according to the second embodiment of the present disclosure. The drawing is a block diagram illustrating a configuration example of the distance measuring section 40 similarly to FIG. 2. The distance measuring section is different from the distance measuring section 40 in FIG. 2 in that the distance measuring section includes a plurality of time code holding sections 220a and 220b, and further includes a control section 250 and a time code selection section 26.

The control section 250 exclusively selects the plurality of time code holding sections 220a and 220b, and performs control to cause the selected time code holding sections 220a and 220b to hold the time code. Furthermore, the control section 250 further controls a time code selection section 260 described later. The control section 250 in the drawing outputs Enable11 and Enable12, which are control signals, to the time code holding section 220a and the time code holding section 220b, respectively. In addition, the control section 250 outputs Enable21 and Enable22, which are control signals, to the time code selection section 260. The control section 250 can be configured by, for example, a state transition machine (state machine). Details of the configuration of the control section 250 will be described later.

The time code holding sections 220a and 220b alternately hold the time codes on the basis of the control of the control section 250. In addition, the time code holding sections 220a and 220b output the held time codes to the time code selection section 260.

The time code selection section 260 selects the plurality of time code holding sections 220a and 220b on the basis of the control of the control section 250. In addition, the time code selection section 260 outputs the time codes of the selected time code holding sections 220a and 220b to the histogram generation section 240. Details of the configuration of the time code selection section 260 will be described later.

### [Configuration of Control Section]

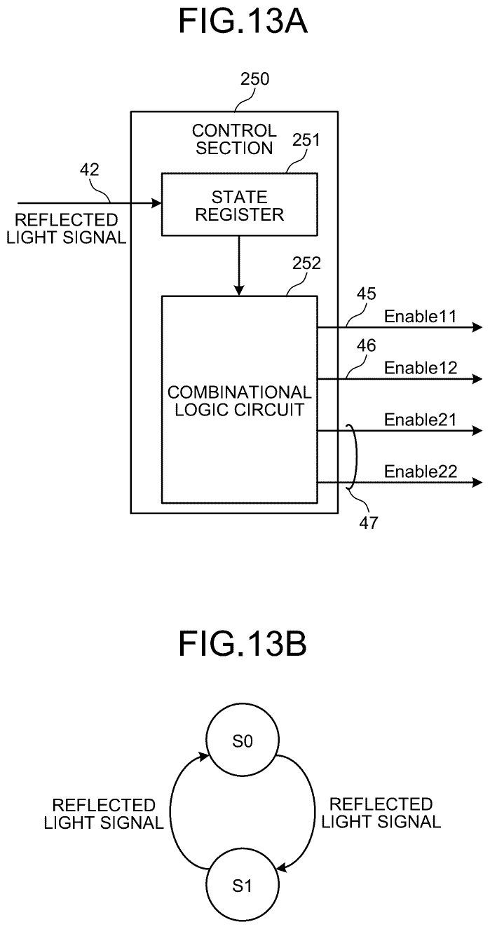

FIG. 13A is a diagram illustrating a configuration example of a control section according to the second embodiment of the present disclosure. The drawing is a block diagram illustrating a configuration example of the control section 250. The control section 250 in the drawing includes a state register 251 and a combinational logic circuit 252.

The state register 251 is a register that holds a state. The state register 251 in the drawing holds two states (state S0 and state S1). The state register 251 can include, for example, a 1-bit D flip-flop. In this case, periods during which the values “0” and “1” are held in the D flip-flop can be made to correspond to state S0 and state S1, respectively. The state register 251 outputs a state value, which is a value corresponding to the state, to the combinational logic circuit 252.

The combinational logic circuit 252 is a circuit that generates a control signal on the basis of the state value output from the state register 251. Specifically, the combinational logic circuit 252 in the drawing generates Enable11, Enable12, Enable21, and Enable22, and outputs them to the time code holding section 220a, the time code holding section 220b, and the time code selection section 260.

FIG. 13B is a diagram illustrating transition of states of the control section according to the second embodiment of the present disclosure. The drawing is a state transition diagram of a state machine in the control section 250. As described above, the state machine of the control section 250 has state S0 and state S1. “S0” and “S1” in the drawing represent these states. In addition, an arrow in the drawing represents a transition condition of the state. As illustrated in the drawing, when the reflected light signal is input, the state transitions to state S0 and state S1 each other. That is, state S0 and state S1 are switched every time the reflected light signal is input.

### [Configuration of Time Code Selection Section]

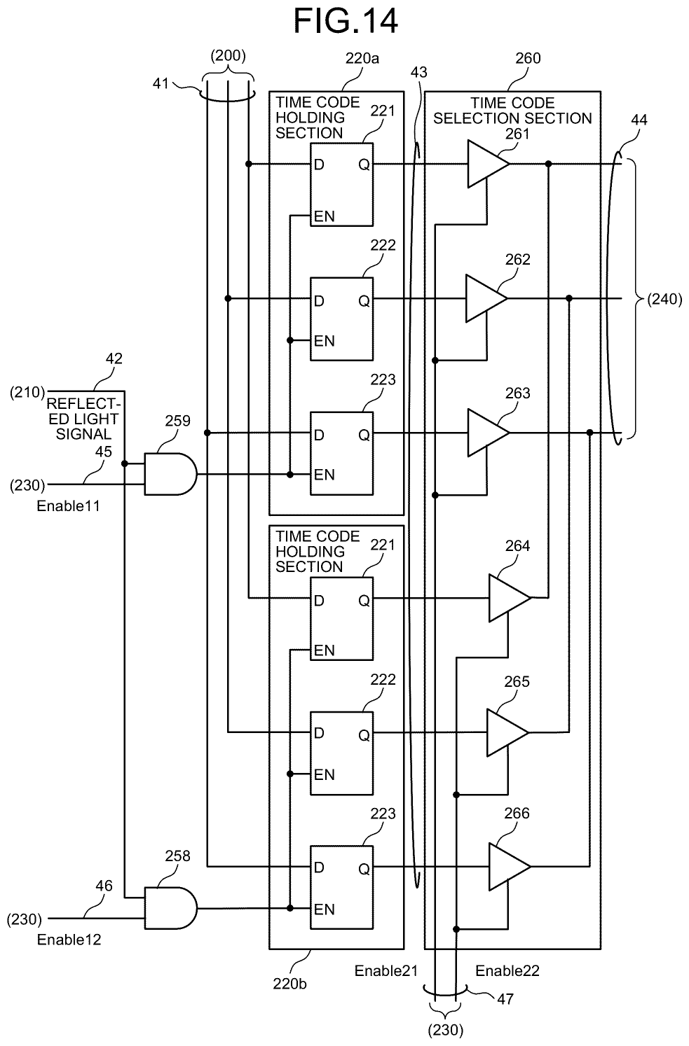

FIG. 14 is a diagram illustrating a configuration example of a time code selection section according to the second embodiment of the present disclosure. The drawing is a circuit diagram illustrating a configuration example of the time code selection section 260. Note that the time code holding sections 220a and 220b are further described in the drawing. Note that, in the drawing, a 3-bit time code is assumed.

The time code holding sections 220a and 220b in the drawing include D latches 221 to 223. The output of an AND gate 259 is connected to the enable terminal of the time code holding section 220a. The reflected light signal and Enable11 are input to the input of the AND gate 259. Similarly, the output of an AND gate 258 is connected to the enable terminal of the time code holding section 220b. The reflected light signal and Enable12 are input to the input of the AND gate 258. In this manner, the time code holding sections 220a and 220b to which the reflected light signal is input can be selected by Enable11 and Enable12.

The time code selection section 260 includes non-inverting buffers 261 to 266. The inputs of the non-inverting buffers 261 to 263 are connected to the Q outputs of the D latches 221 to 223 of the time code holding section 220a. Enable21 is input to control inputs of the non-inverting buffers 261 to 263. The inputs of the non-inverting buffers 264 to 266 are connected to the Q outputs of the D latches 221 to 223 of the time code holding section 220b. Enable22 is input to control inputs of the non-inverting buffers 264 to 266. Outputs of the non-inverting buffers 264 to 266 are connected to outputs of the non-inverting buffers 261 to 263, respectively. Note that the outputs of the non-inverting buffers 261 to 263 are connected to the histogram generation section 240. In this manner, the time code holding sections 220a and 22b can be selected by Enable21 and Enable22.

### [Generation of Histogram]

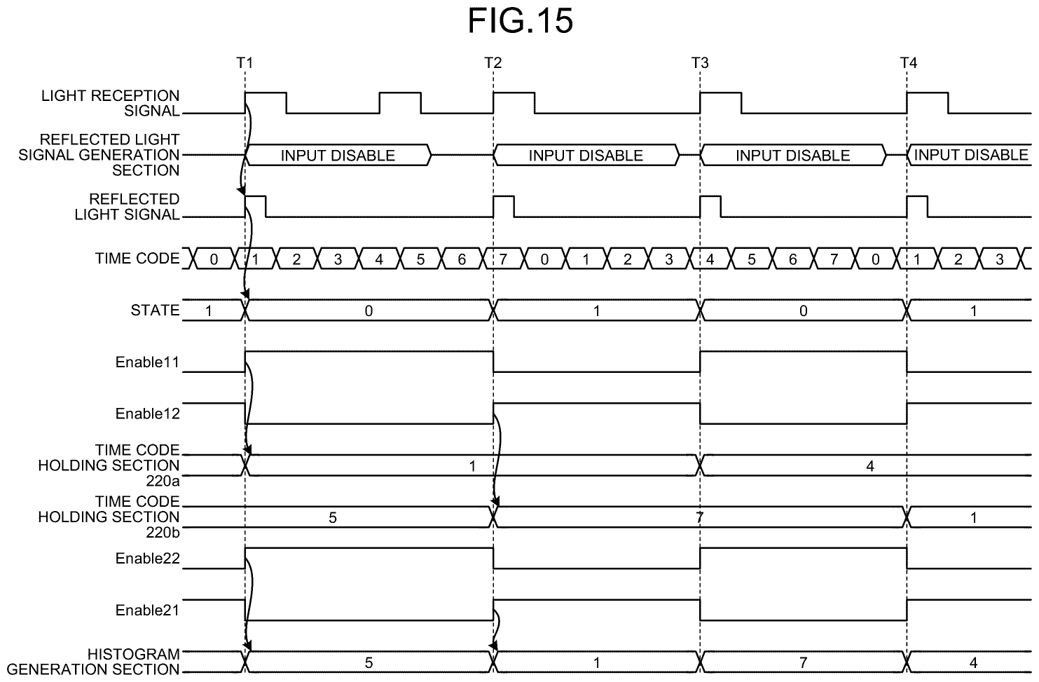

FIG. 15 is a diagram illustrating an example of generation of a histogram according to the second embodiment of the present disclosure. Similarly to FIG. 10, the drawing is a timing chart illustrating an example of generation of a histogram of time-of-flights in the distance measuring section 40. “Reflected light signal generation section” in the drawing represents a state of the reflected light signal generation section 210. “State” represents states S0 and S1 of the control section 250. “Enable1l”, “Enable12”, “Enable21”, and “Enable22” represent the waveforms of Enable11, Enable12, Enable21, and Enable22, respectively. “Time code holding section 220a” and “time code holding section 220b” represent the time codes held in time code holding sections 220a and 220b. In addition, “histogram generation section” represents a time code output to the histogram generation section 240. Other notations similar to those in FIG. 10 are used.

In the drawing, when the light reception signal is input to the reflected light signal generation section 210, the reflected light signal is generated. At this time, an input disable period in which the input of the light reception signal is not received is set in the reflected light signal generation section 210. In addition, each time the reflected light signal is input, the state transitions.

At T1 in the drawing, a reflected light signal is generated. The state transitions to state S0 on the basis of the generated reflected light signal. At the time of the transition to state S0, the time code holding section 220a is selected, and the time code (value “1”) is held in the time code holding section 220a. In addition, in state S0, the time code selection section 260 selects the time code holding section 220b, and the time code (value “5”) held in the time code holding section 220b is output to the histogram generation section 240.

At T2 in the drawing, the state transitions to state S1 on the basis of the generated reflected light signal. At the time of the transition to state S1, the time code holding section 220b is selected, and the time code (value “7”) is held in the time code holding section 220b. In addition, the time code holding section 220a is selected by the time code selection section 260 in state S1, and the time code (value “1”) held in the time code holding section 220a is output to the histogram generation section 240 at T1.

As described above, the time code holding sections 220a and 220b are alternately (exclusively) selected by the control section 250 constituting the state machine, and the time code at the timing when the reflected light signal is generated is held. In addition, a time code holding section different from the time code holding section 220a or the time code holding section 220b selected for holding the time code is further selected and held, and the held time code is output to the histogram generation section 240. That is, at each timing of holding the time code and outputting the held time code, the time code holding section 220a and the time code holding section 220b are exclusively selected, and holding of the time code and outputting of the held time code are alternately performed. The holding of these time codes and the output of the held time codes are performed on the basis of the reflected light signal.

In addition, the light detection element 2 according to the second embodiment of the present disclosure selects the plurality of time code holding sections 220, holds the time code in the selected time code holding section 220, and controls the output of the held time code by the state machine of the control section 250. This state machine includes a clock signal asynchronous circuit whose state transitions on the basis of the reflected light signal. For this reason, a clock signal is unnecessary in processing of capturing the time code and outputting to the histogram generation section 240, and power consumption can be reduced.

### [Another Configuration of Distance Measuring Section]

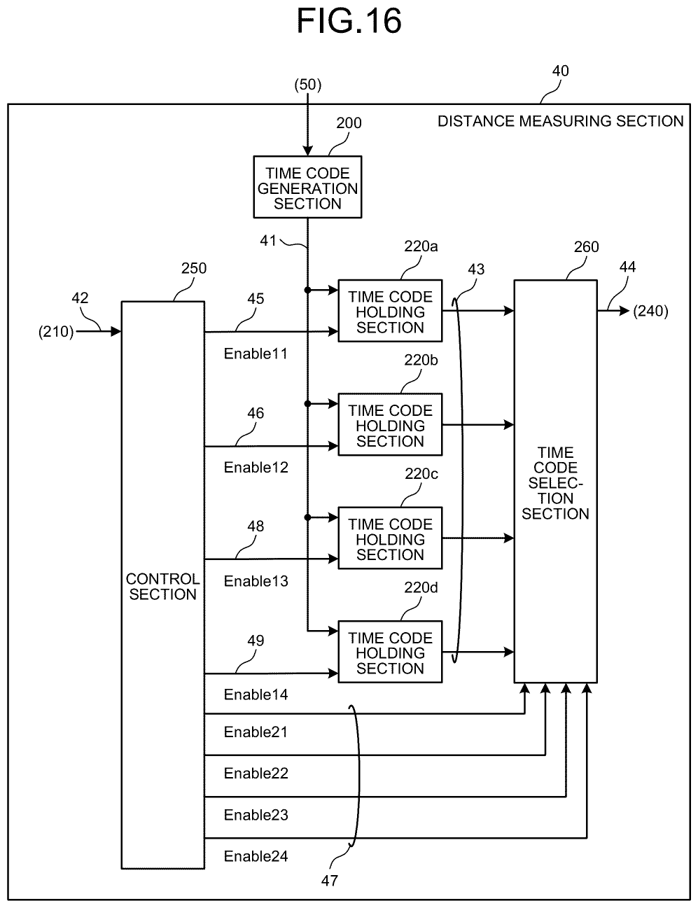

FIG. 16 is a diagram illustrating another configuration example of the distance measuring section according to the second embodiment of the present disclosure. The drawing is a block diagram illustrating a configuration example of the distance measuring section 40 similarly to FIG. 12. The distance measuring section 40 in the drawing is different from the distance measuring section 40 in FIG. 12 in further including time code holding sections 220c and 220d.

The time code holding sections 220c and 220d can have configurations similar to the time code holding section 220a in FIG. 14.

The control section 250 in the drawing is configured as a state machine having four states of state S0, state S1, state S2, and state S3. In this case, a 2-bit Johnson counter or a 4-bit ring counter can be used as the state register 251. Furthermore, the control section 250 further generates Enable113, Enable114, Enable123, and Enable124, which are control signals. Enable113 and Enable114 are signals for selecting the time code holding sections 220c and 220d, respectively. Enable123 and Enable124 are signals for selecting the time codes held in the time code holding sections 220c and 220d, respectively.

The time code selection section 260 in the drawing selects one of the time codes held in the time code holding sections 220a, 220b, 220c, and 220d and outputs the selected time code to the histogram generation section 240.

### [Generation of Histogram]

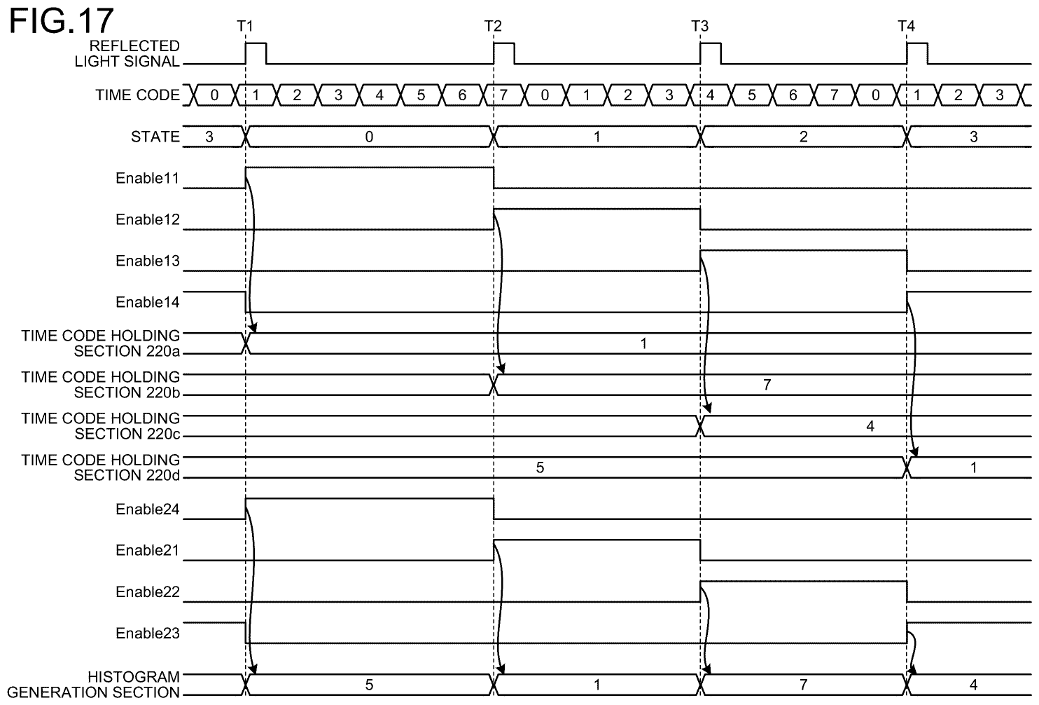

FIG. 17 is a diagram illustrating another example of the generation of the histogram according to the second embodiment of the present disclosure. Similarly to FIG. 15, the drawing is a timing chart illustrating an example of generation of a histogram of time-of-flights in the distance measuring section 40. “Enable13”, “Enable14”, “Enable23”, and “Enable24” in the drawing represent waveforms of Enable13, Enable14, Enable23, and Enable24, respectively. “Time code holding section 220c” and “time code holding section 220d” represent the time codes held in the time code holding sections 220c and 220d. Other notations similar to those in FIG. 12 are used.

In the drawing, every time the reflected light signal is input, the state sequentially transitions from S0 to S3. At T1 in the drawing, a reflected light signal is generated, and the state transitions to state S0 on the basis of the generated reflected light signal. At the time of the transition to state S0, the time code holding section 220a is selected, and the time code (value “1”) is held in the time code holding section 220a. In addition, in state S0, the time code holding section 220d is selected by the time code selection section 260, and the time code (value “5”) held in the time code holding section 220d is output to the histogram generation section 240.

At T2, the state transitions to state S1 on the basis of the generated reflected light signal. At the time of the transition to state S1, the time code holding section 220b is selected, and the time code (value “7”) is held in the time code holding section 220b. In addition, in state S1, the time code selection section 260 selects the time code holding section 220a, and the held time code (value “1”) is output to the histogram generation section 240.

At T3, the state transitions to state S2 on the basis of the generated reflected light signal. At the time of the transition to state S2, the time code holding section 220c is selected, and the time code (value “4”) is held in the time code holding section 220c. In addition, in state S2, the time code selection section 260 selects the time code holding section 220b, and the held time code (value “7”) is output to the histogram generation section 240.

At T4, the state transitions to state S3 on the basis of the generated reflected light signal. At the time of the transition to state S3, the time code holding section 220d is selected, and the time code (value “1”) is held in the time code holding section 220d. In addition, in state S3, the time code selection section 260 selects the time code holding section 220c, and the held time code (value “4”) is output to the histogram generation section 240.

As compared with the case of FIG. 15, it is possible to allow a margin in the switching timing of the time code holding section 220. Note that a state in which the time code is held in the time code holding section 220a or the like and a state in which the time code held in the histogram generation section 240 is transferred can be shifted from each other.

Note that the configuration of the distance measuring section 40 is not limited to this example. For example, the time code holding section 220 including a D flip-flop can be used instead of the D latch.

As described above, the distance measuring device 1 according to the second embodiment of the present disclosure includes the plurality of time code holding sections 220. By exclusively selecting the plurality of time code holding sections 220 to hold the time code, it is possible to generate the histogram at high speed and to generate the histogram with a reduced class width. In addition, by configuring the control section 250 and the like by an asynchronous circuit that does not require a clock signal, it is also possible to reduce power consumption in histogram generation.

### 3. Third Embodiment

The distance measuring device 1 of the first embodiment described above generates the time code and causes the time code holding section 220 to hold the time code. On the other hand, a distance measuring device 1 according to a third embodiment of the present disclosure is different from the above-described first embodiment in that a time code is divided into a plurality of time code groups, and a period for generating a histogram is added for each time code group on the basis of an identification signal corresponding to each time code group.

### [Configuration of Distance Measuring Section]

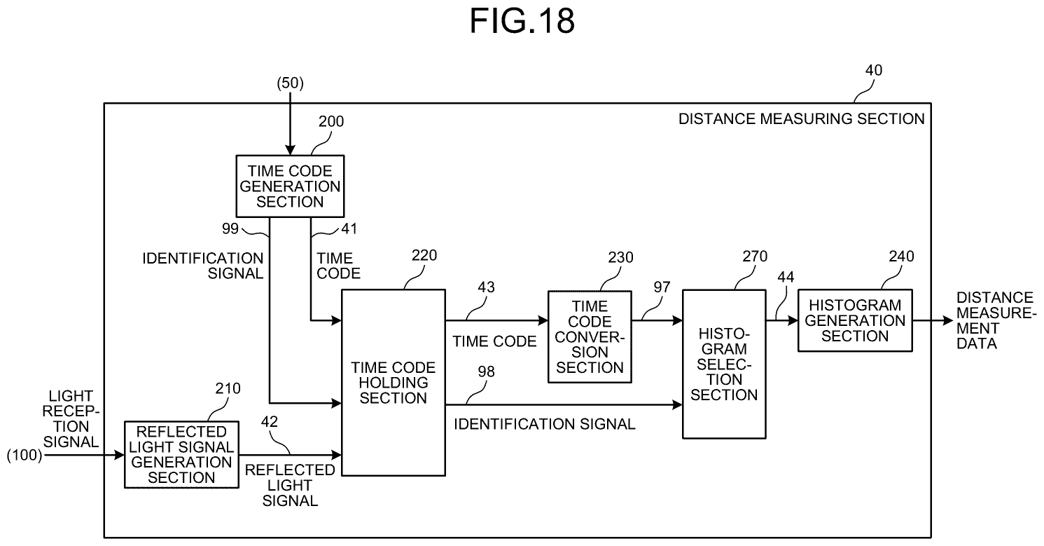

FIG. 18 is a diagram illustrating a configuration example of a distance measuring section according to the third embodiment of the present disclosure. The drawing is a block diagram illustrating a configuration example of the distance measuring section 40 similarly to FIG. 2. The distance measuring section 40 in the drawing further includes a histogram selection section 270 and a plurality of histogram generation sections (histogram generation sections 240a and 240b to be described later), and is different from the distance measuring section 40 in FIG. 2 in that the time code generation section 200 generates an identification signal in addition to a time code.

The distance measuring section 40 in the drawing is assumed to be applied to an application in which distance measurement in a region separated by a specific distance is performed with high accuracy. For example, the present invention can be applied to an application for acquiring a three-dimensional shape of a target object. Specifically, a time-of-flight detection period is set for a region including a target object of interest to a user or the like of the distance measuring device 1. A histogram of time-of-flight with a relatively narrow class width is generated in this time-of-flight detection period. Note that the time-of-flight corresponding to the distance to the region for which the time-of-flight detection period is set is referred to as time-of-flight of interest. This time-of-flight of interest can be detected, for example, by generating a histogram of time-of-flight with a relatively wide class width.

In addition, the distance measuring section 40 in the drawing divides the time code into a plurality of time code groups and generates an identification signal for identifying the time code group. A histogram is generated for each time code group. As the time code group, for example, a time code group including even-numbered time codes and a time code group including odd-numbered time codes can be applied. Hereinafter, in the present embodiment, an even-numbered time code group and an odd-numbered time code group are assumed.

The time code generation section 200 in the drawing generates time-series time codes and simultaneously generates identification signals for identifying a time code group including the time codes. The generated time codes and identification signals are output to the time code holding section 220.

The time code holding section 220 in the drawing holds the time codes and the identification signals on the basis of the reflected light signal. Among them, the time codes are output to the time code conversion section 230, and the identification signals are output to the histogram selection section 270.

The histogram selection section 270 selects a histogram. A histogram generation section 240 (histogram generation sections 240a and 240b to be described later) in the drawing generates a histogram for each time code group. The histogram selection section 270 distributes the time codes output from the time code conversion section 230 into time code groups based on the identification signal. The distributed time codes are output to the histogram generation sections 240a and 240b, respectively. Details of the configuration of the histogram selection section 270 will be described later.

The histogram generation section 240 in the drawing individually creates histograms of time code groups. As described later, the histogram generation section 240 includes histogram generation sections 240a and 240b.

### [Configuration of Time Code Holding Section]

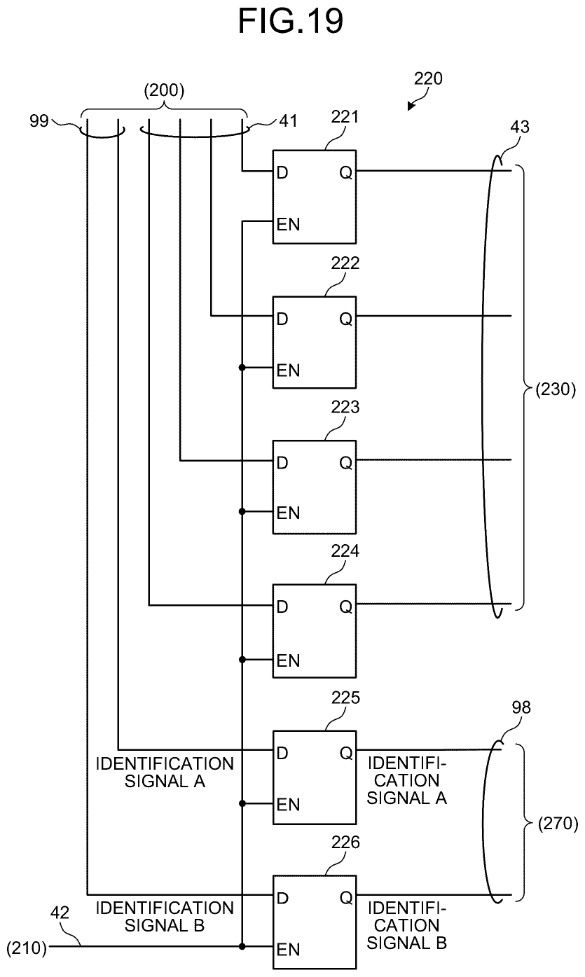

FIG. 19 is a diagram illustrating a configuration example of a time code holding section according to the third embodiment of the present disclosure. The drawing is a diagram illustrating a configuration example of the time code holding section 220 similarly to FIG. 7. The time code holding section 220 in the drawing is different from the time code holding section 220 in FIG. 7 in further including D latches 225 and 226. The D latches 225 and 226 hold the identification signal A and the identification signal B, respectively. The identification signal A and the identification signal B are identification signals corresponding to an even-numbered time code group and an odd-numbered time code group, respectively. The identification signals A and B retained in the D latches 225 and 226 are output to the histogram selection section 270.

### [Configuration of Histogram Selection Section]

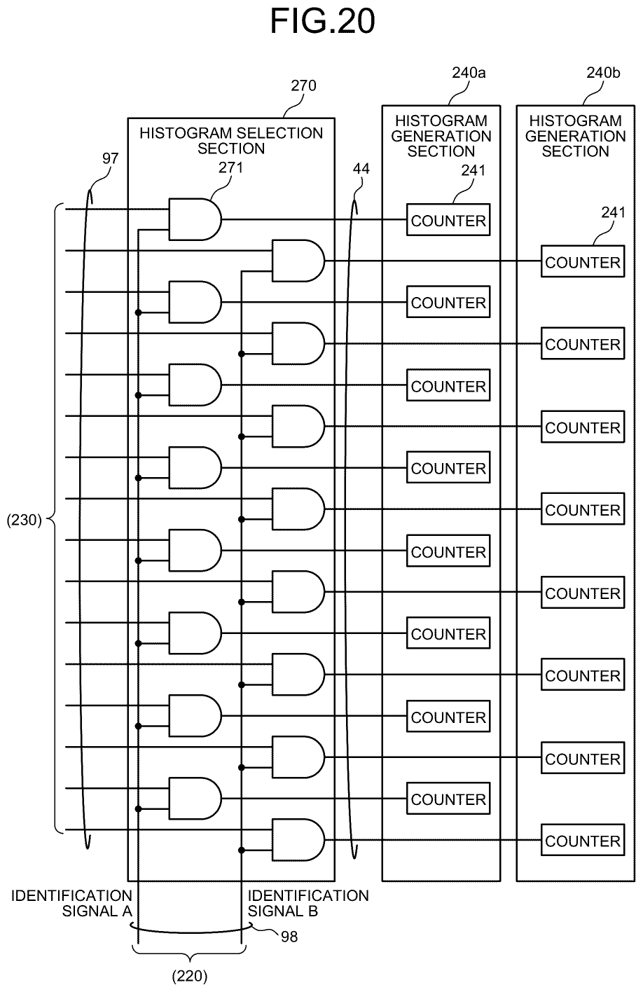

FIG. 20 is a diagram illustrating a configuration example of a histogram selection section according to the third embodiment of the present disclosure. The drawing is a diagram illustrating a configuration example of the histogram selection section 270. In addition, the histogram generation section 240 is further described in the drawing.

The histogram selection section 270 includes, for example, a plurality of two-input AND gates 271. These AND gates 271 are arranged for each signal line 97 from the time code conversion section 230. In addition, the AND gates 271 are divided for each corresponding time code group, and the identification signal A and the identification signal B are input thereto. As illustrated in the drawing, the output of the AND gate 271 corresponding to the even-numbered time code group is connected to the counter 241 of the histogram generation section 240a. Further, the output of the AND gate 271 corresponding to the odd-numbered time code group is connected to the counter 241 of the histogram generation section 240b. As described above, the histogram selection section 270 selects the one-hot code signal from the time code conversion section 230 for each time code group and outputs the one-hot code signal to the histogram generation sections 240a and 240b.

The histogram generation section 240 in the drawing includes histogram generation sections 240a and 240b. Each of the histogram generation sections 240a and 240b is configured by arranging a plurality of counters 241. The time codes (one-hot codes) distributed by the time code conversion section 230 are input to the histogram generation sections 240a and 240b. The histogram generation sections 240a and 240b each generate a histogram of a corresponding time code group.

### [Generation of Histogram]

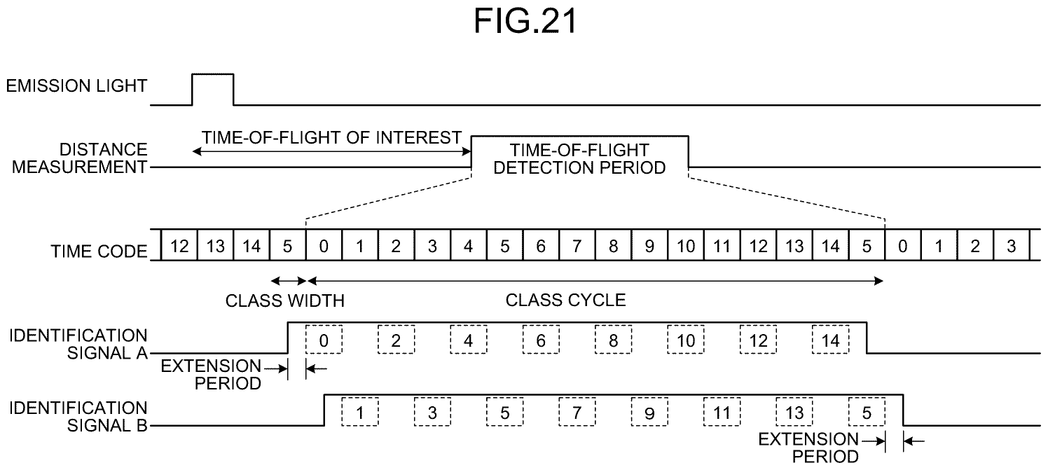

FIG. 21 is a diagram illustrating an example of generation of a histogram according to the third embodiment of the present disclosure. The drawing is a timing chart illustrating an example of generation of a histogram of time-of-flights in the distance measuring section 40. “Emission light” in the drawing represents a waveform of the emission light from the light emitting element 10. “Distance measurement” represents a period to be a target of distance measurement with respect to the emission light. “Time code” represents a time-series time code. “Identification signal A” and “identification signal B” represent waveforms of the identification signal A and the identification signal B, respectively.

The time-of-flight detection period is set in a region separated by the time-of-flight of interest from the emission of the emission light of the light emitting element 10. This time-of-flight detection period can be set by the distance measurement control section 50 in FIG. 1. The time-of-flight detection period is set to a period that is a multiple of the class width (specific cycle) of the time code, and a period synchronized with the class cycle that is the entire time width of the histogram of the time-of-flight is set as the maximum width. Specifically, the width is set to be equal to a time code (in the drawing, time codes “0” to “15” are illustrated) making one round.

The time code generation section 200 generates an identification signal of a time code group in the set time-of-flight detection period. At this time, the time code generation section 200 generates an identification signal of a wide period for the time code in the corresponding time code group. For example, the time code generation section 200 can generate an identification signal obtained by extending substantially a half period of a specific cycle before and after the time code. In the identification signal A corresponding to the even-numbered time code group, the rising is a position extended in the period of the time code “15” immediately before the time-of-flight detection period, and the falling is a position extended in the period of the last time code “15” of the time-of-flight detection period. In the identification signal B corresponding to the odd-numbered time code group, the rising is a position extended in the period of the first time code “0” in the time-of-flight detection period, and the falling is a position extended in the period of the time code “0” immediately after the time-of-flight detection period. A dotted rectangle in the drawing represents a time code for each time code group.

A period of the identification signal A includes even-numbered time codes, and a period of the identification signal B includes odd-numbered time codes. In addition, an extension period is added to the identification signal A immediately before the time-of-flight detection period, and an extension period is added to the identification signal B immediately after the time-of-flight detection period. By adding the extension period, the reflected light signal generated in the vicinity of the boundary of the time-of-flight detection period can be reflected on the histogram. In the drawing, since the extension periods of the identification signal A and the identification signal B are added to the time code “0” and the time code “15”, it is possible to prevent missing of the time code “0” and the time code “15” for generating a histogram at the boundary of the time-of-flight detection period. Note that any one of the extension period immediately before the time-of-flight detection period in the identification signal A and the extension period immediately after the time-of-flight detection period in the identification signal B can be added.

In addition, the identification signal A in the drawing represents an example in which an extension period is further added after the period of the last time code “14” of the time code group corresponding to the identification signal A. In addition, the identification signal B in the drawing represents an example in which an extension period is further added before the period of the first time code “1” of the time code group corresponding to the identification signal B. In this manner, the identification signals A and B in the drawing add the extension period before and after the period of the time code included in the own time code group. As a result, it is possible to prevent missing of the time code for generating the histogram in the switching portion of the time code group. Note that any one of the extension periods of the front portion and the rear portion of the period of the time code group in the identification signal A may be added. Similarly, any one of the extension periods of the front part and the rear part of the period of the time code group in the identification signal B may be added.

As described above, the time-of-flight detection period is set to a period synchronized with the class width of the time code. However, in a case where the extension period described above is not provided, a signal representing a time-of-flight detection period or a signal representing a time code is temporally shifted in the process of signal transmission, and the time-of-flight detection period may take the time code “0” and the time code “15” described above. In this case, the time code “0” and the time code “15” cannot be captured with respect to the reflected light, and an error occurs in the histogram.

Therefore, an extension period is added to the identification signal A and the identification signal B. Even in a case where a temporal shift occurs in the signal representing the time-of-flight detection period and the signal representing the time code, it is possible to prevent the time-of-flight detection period from being taken for the time codes “0” and “15”. In this case, the identification signal includes periods of different time code groups. Specifically, the identification signal A includes a partial period of the time code “15” immediately before the time-of-flight detection period which is an odd-numbered time code. However, since the histogram is generated for each time code group, occurrence of malfunction can be prevented. The time code “15” immediately before the time-of-flight detection period is not selected by the histogram selection section 270 described with reference to FIG. 20 and is not transmitted to the histogram generation section 240a. Therefore, even in a case where the identification signal A is applied during the period of the time code “15” immediately before the time-of-flight detection period, it is not reflected on the histogram, and occurrence of malfunction can be prevented.

Note that the configuration of the distance measuring section 40 is not limited to this example. For example, the time code can be divided into three or more regions. Furthermore, for example, the time code holding section 220 configured by a D flip-flop can be used instead of the D latch.

The configuration of the distance measuring device 1 other than this is similar to the configuration of the distance measuring device 1 according to the first embodiment of the present disclosure, and thus the description thereof will be omitted.

As described above, the distance measuring device 1 according to the third embodiment of the present disclosure sets the time-of-flight detection period and generates a histogram of the time-of-flight. Further, the time codes are divided into time code groups to generate histograms. At this time, an identification signal is generated to identify a time code group, and an extension period is added to the identification signals that take before and after the time-of-flight detection period. As a result, the light reception signal detected in the vicinity of the boundary of the time-of-flight detection period can be reflected on the histogram, and the error of the histogram of the time-of-flight can be reduced.

### 4. Fourth Embodiment

In the distance measuring device 1 of the third embodiment described above, the time codes are divided into the even-numbered time code group and the odd-numbered time code group. On the other hand, a distance measuring device 1 according to a fourth embodiment of the present disclosure is different from the above-described third embodiment in that time codes are divided into a first half time code group and a second half time code group.

### [Configuration of Histogram Selection Section]

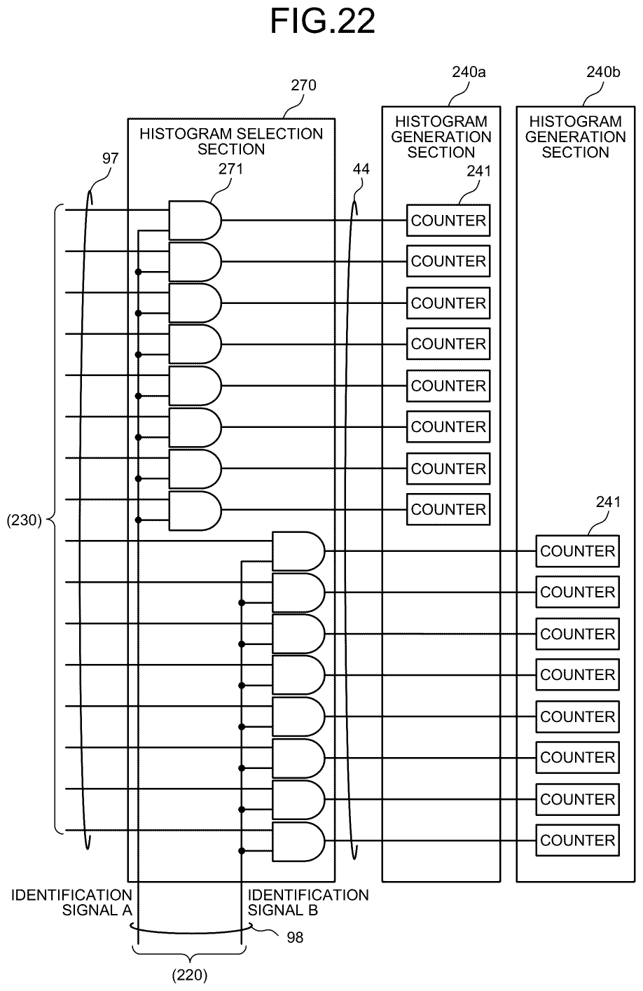

FIG. 22 is a diagram illustrating a configuration example of a histogram selection section according to the fourth embodiment of the present disclosure. The drawing is a diagram illustrating a configuration example of the histogram selection section 270 and the histogram generation sections 240a and 240b similarly to FIG. 20.

In the present embodiment, the time-series time codes are divided into a plurality of periods. Specifically, the time-series time codes are divided into a first half time code group and a second half time code group of a period corresponding to the time-of-flight detection period. In the drawing, the identification signal A corresponds to a first half time code group, and the identification signal B corresponds to a second half time code group.

In the histogram selection section 270 in the drawing, the AND gate 271 is arranged to be divided into a first half time code group and a second half time code group, and the identification signal A and the identification signal B are input thereto, respectively. In addition, the histogram generation section 240a corresponds to the first half time code group, and the histogram generation section 240b corresponds to the second half time code group.

### [Generation of Histogram]

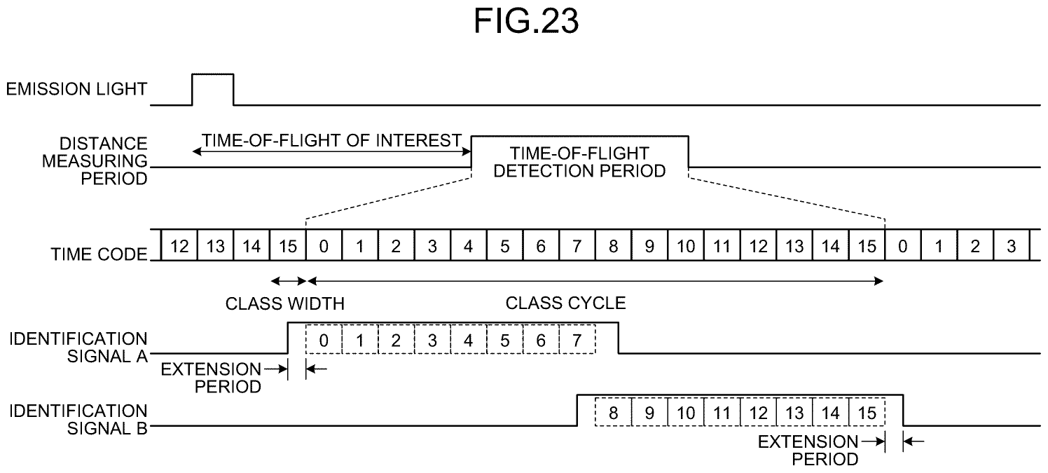

FIG. 23 is a diagram illustrating an example of generation of a histogram according to the fourth embodiment of the present disclosure. Similarly to FIG. 21, the drawing is a timing chart illustrating an example of generation of a histogram of time-of-flights in the distance measuring section 40.

In the drawing, the identification signal A and the identification signal B correspond to a first half time code group and a second half time code group, respectively. In addition, similarly to the identification signal A and the identification signal B of FIG. 20, the identification signal A and the identification signal B of the drawing are set to a period in which substantially half of the specific cycle is extended. The period of the identification signal A includes first half time codes (“0” to “7”), and the period of the identification signal B includes second half time codes (“8” to “15”). In addition, an extension period is added to the identification signal A immediately before the time-of-flight detection period and a period of time code “8”, and an extension period is added to the identification signal B immediately after the time-of-flight detection period and a period of time code “7”. As a result, it is possible to prevent missing of the time code “0”, the time code “7”, the time code “8”, and the time code “15”, and reflect the reflected light signal generated in the vicinity of the boundary of the time-of-flight detection period on the histogram.

Note that, similarly to the case of FIG. 21, any one of the extension period immediately before the time-of-flight detection period in the identification signal A in the drawing and the extension period immediately after the time-of-flight detection period in the identification signal B in the drawing can be added. In addition, any one of the extension periods of the front portion and the rear portion of the period of the time code group in the identification signal A may be added. In addition, any one of the extension periods of the front portion and the rear portion of the period of the time code group in the identification signal B may be added.

The configuration of the distance measuring device 1 other than this is similar to the configuration of the distance measuring device 1 according to the third embodiment of the present disclosure, and thus the description thereof will be omitted.

As described above, the distance measuring device 1 according to the fourth embodiment of the present disclosure divides the time codes into the first half time code group and the second half time code group. In the identification signal, an extension period is added to a portion that takes before and after the time-of-flight detection period. As a result, the light reception signal detected in the vicinity of the boundary of the time-of-flight detection period can be reflected on the histogram, and the error of the histogram of the time-of-flight can be reduced.

### 5. Fifth Embodiment

The distance measuring device 1 of the third embodiment described above includes the time code holding section 220. On the other hand, a distance measuring device 1 according to a fifth embodiment of the present disclosure is different from the above-described third embodiment in that the distance measuring device 1 includes a plurality of time code holding sections 220a and 220b.

### [Configuration of Distance Measuring Section]

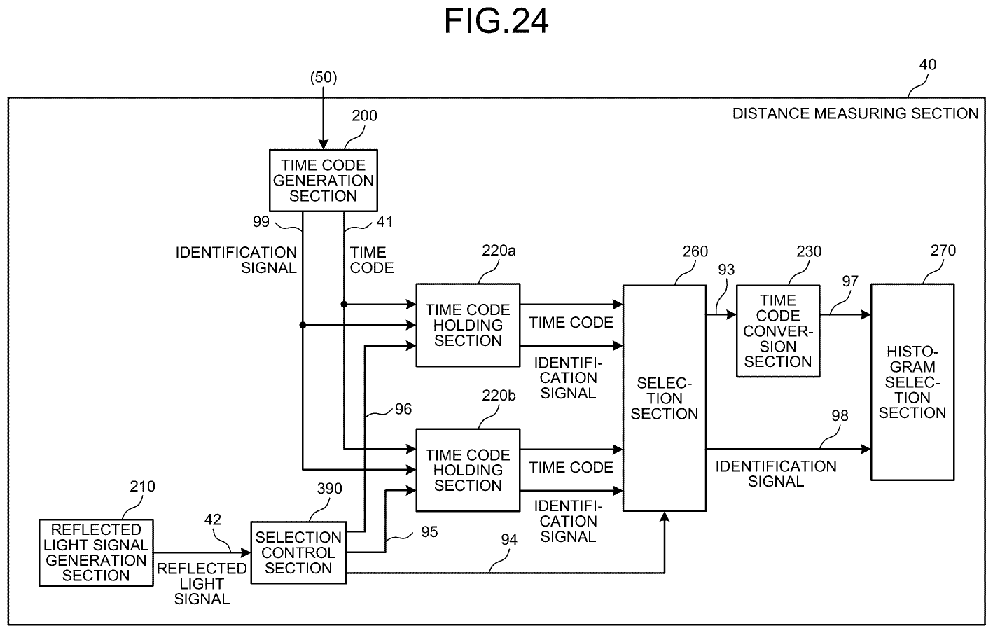

FIG. 24 is a diagram illustrating a configuration example of a distance measuring section according to the fifth embodiment of the present disclosure. The drawing is a block diagram illustrating a configuration example of the distance measuring section 40 similarly to FIG. 18. The distance measuring section 40 in the drawing is different from the distance measuring section 40 in FIG. 18 in further including time code holding sections 220a and 220b and a selection control section 390. Note that, in the drawing, the description of the histogram generation sections 240a and 240b is omitted.

The time code holding sections 220a and 220b alternately hold the time code and the identification signal. The time code holding sections 220a and 220b each output the held time code and identification signal to the time code selection section 260.

The time code selection section 260 selects the time code holding sections 220a and 220b on the basis of the control of the selection control section 390. The time code selection section 260 outputs the time codes and the identification signals from the selected time code holding sections 220a and 220b to the time code conversion section 230 and the histogram selection section 270.

The selection control section 390 controls selection of the time code holding sections 220a and 220b. The selection control section 390 performs control to alternately select the time code holding sections 220a and 220b to hold the time code and the identification signal. In addition, the selection control section 390 further controls selection of the time code holding sections 220a and 220b in the time code selection section 260.

The configuration of the distance measuring device 1 other than this is similar to the configuration of the distance measuring device 1 according to the third embodiment of the present disclosure, and thus the description thereof will be omitted.

As described above, the distance measuring device 1 according to the fifth embodiment of the present disclosure includes the plurality of time code holding sections 220a and 220b and alternately generates the time code and the identification signal. It is possible to generate a histogram at high speed and to generate a histogram with a reduced class width.

### 6. Sixth Embodiment

In the distance measuring device 1 of the third embodiment described above, the correspondence of the time code with respect to the time-of-flight detection period is fixed in the distance measuring period. On the other hand, a distance measuring device 1 according to a sixth embodiment of the present disclosure is different from the above-described third embodiment in that a time code is adjusted for each distance measuring period.

### [Configuration of Distance Measuring Section]

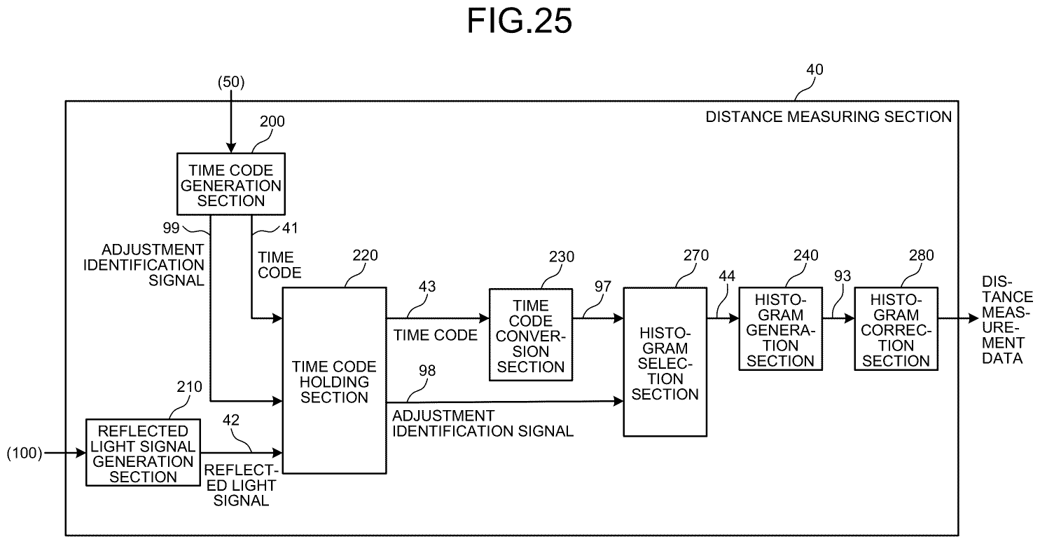

FIG. 25 is a diagram illustrating a configuration example of a distance measuring section according to the sixth embodiment of the present disclosure. The drawing is a block diagram illustrating a configuration example of the distance measuring section 40 similarly to FIG. 18. The distance measuring section 40 in the drawing is different from the distance measuring section 40 in FIG. 18 in further including a histogram correction section 280.

The distance measuring section 40 in the drawing adjusts time-series time codes in a distance measuring period repeated in a predetermined cycle, and generates a histogram by shifting the positions of the classes of the histogram in a time-of-flight detection period.

The time code generation section 200 adjusts the time code corresponding to the time-of-flight detection period for each distance measuring period to generate an adjustment time code. In addition, the time code generation section 200 further generates an adjustment identification signal that is an identification signal corresponding to the adjustment time code. The adjustment of the time codes will be described later.

The time code holding section 220 holds an adjustment time code and an adjustment identification signal. In addition, the histogram generation section 240 creates a histogram on the basis of the adjustment time code and the adjustment identification signal.

The histogram correction section 280 corrects the histogram in which the adjustment time code is generated. The correction of the histogram will be described later.

### [Adjustment of Time Codes]

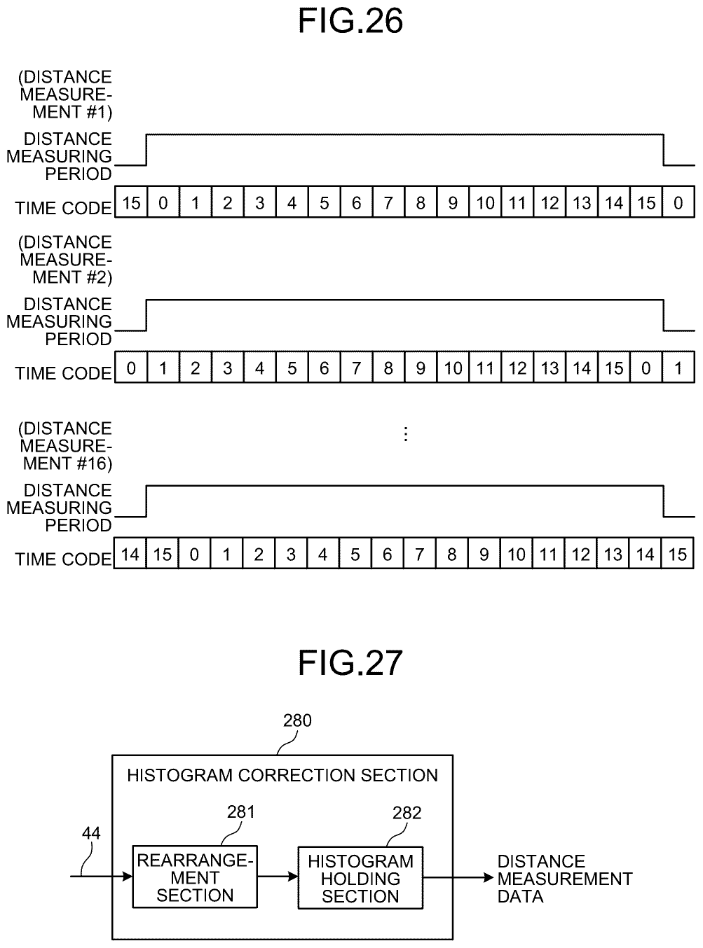

FIG. 26 is a diagram illustrating an example of adjustment of time codes according to the sixth embodiment of the present disclosure. The drawing is a diagram for explaining adjustment of time codes for each distance measuring period. “Distance measurement #1” and the like in the drawing represent time-series distance measuring periods. At this time, a time-series distance measuring period is identified by a number following “#”.

In the distance measuring period #1, the time codes in the time-of-flight detection period are arranged in the order of values “0” to “15” similarly to FIG. 21. On the other hand, in the distance measuring period #2, the time codes are shifted by one class width. Specifically, the time codes in the time-of-flight detection period are arranged in the order of values “1” to “0”. That is, the initial values of the time codes are shifted in the arrangement order. Such adjustment of shifting the arrangement of the time codes is sequentially performed to generate a histogram for each distance measuring period. By adjusting the time codes, histograms are sequentially generated at positions where the classes are shifted. The histogram correction section 280 described later corrects the shift of the histogram.

### [Configuration of Histogram Correction Section]

FIG. 27 is a diagram illustrating a configuration example of a histogram correction section according to the sixth embodiment of the present disclosure. The drawing is a diagram illustrating a configuration example of the histogram correction section 280. The histogram correction section 280 includes a rearrangement section 281 and a histogram holding section 282.

The rearrangement section 281 rearranges the histograms. The rearrangement section 281 performs correction by rearranging the histograms generated at the positions where the classes are shifted by the above-described adjustment of the time codes.

The histogram holding section 282 holds the histogram corrected by the rearrangement section 281.

### [Correction of Histogram]

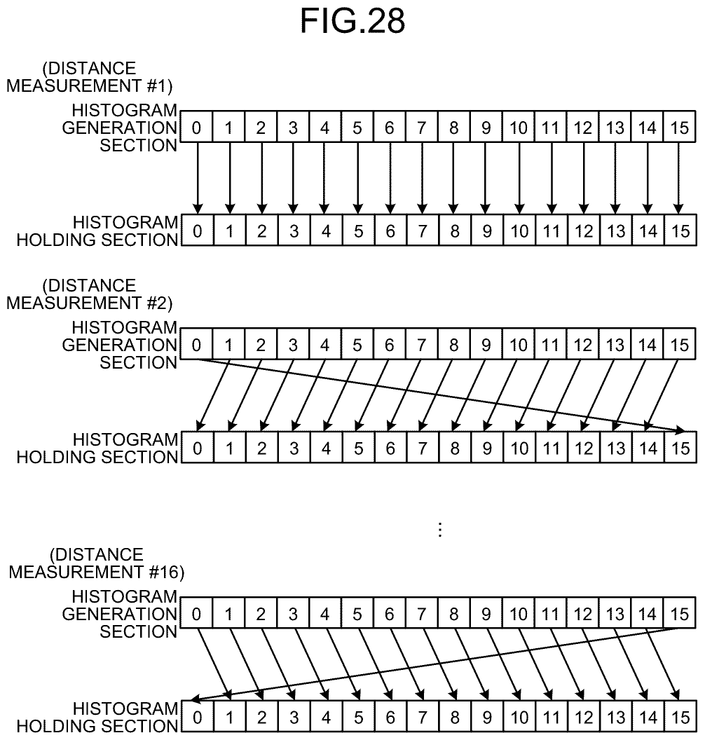

FIG. 28 is a diagram illustrating an example of histogram correction according to the sixth embodiment of the present disclosure. The drawing is a diagram for explaining histogram correction in the rearrangement section 281. In the drawing, “histogram generation section” represents a histogram generated by the histogram generation section 240. A rectangle in the drawing represents a class, and a number identifies a class corresponding to the one-hot code. In addition, “histogram holding section” represents a histogram held by the histogram holding section 282.

In the distance measuring period #1, the histogram generated by the histogram generation section 240 is held in the histogram holding section 282 for each class. In the distance measuring period #2, the histogram generated by the histogram generation section 240 is rearranged to shift the classes and added to the histogram held in the histogram holding section 282. Such class rearrangement is sequentially performed to correct the histogram.

### [Another Configuration of Distance Measuring Section]

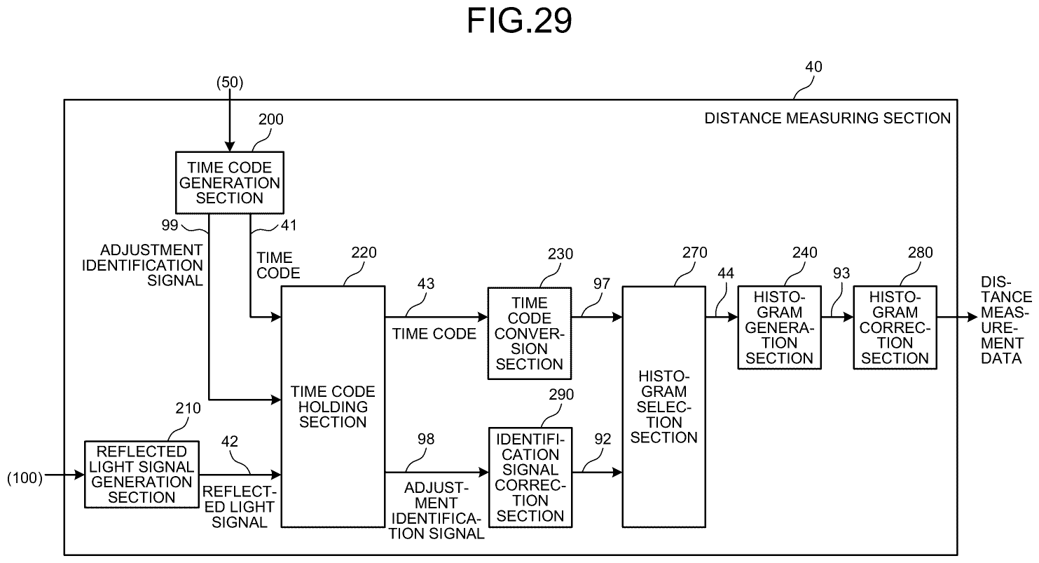

FIG. 29 is a diagram illustrating another configuration example of the distance measuring section according to the sixth embodiment of the present disclosure. The drawing is a block diagram illustrating a configuration example of the distance measuring section 40 similarly to FIG. 25. The distance measuring section 40 in the drawing is different from the distance measuring section 40 in FIG. 18 in further including an identification signal correction section 290.

The distance measuring section 40 in the drawing assumes a case where the time code group described in FIG. 23 is divided into a first half time code group and a second half time code group. In this case, the adjustment identification signals (the identification signal A and the identification signal B) correspond to the first half time code group and the second half time code group, respectively, but inconsistency occurs in the operation of the histogram selection section 270 due to the adjustment of the time codes described above. The identification signal correction section 290 corrects the adjustment identification signal to prevent inconsistency of the histogram selection section 270.

### [Configuration of Identification Signal Correction Section]

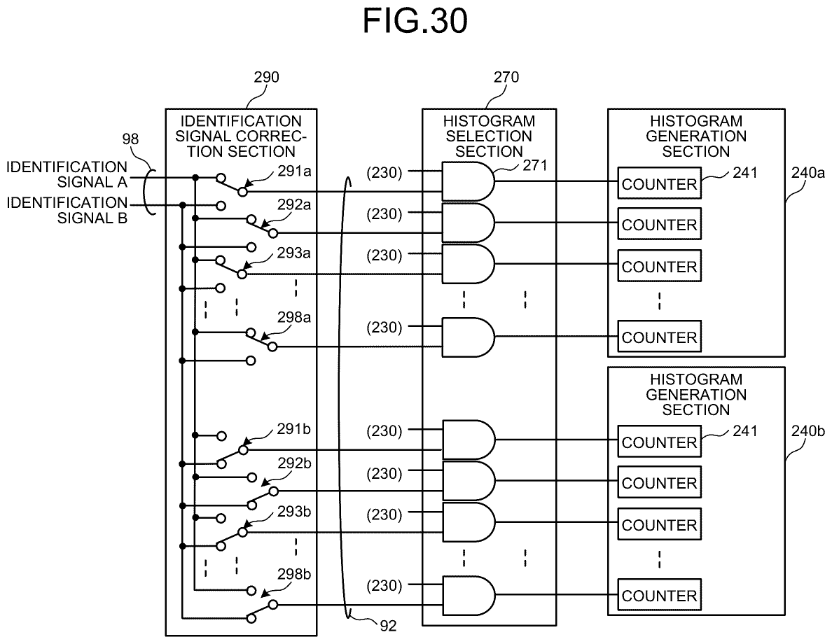

FIG. 30 is a diagram illustrating a configuration example of an identification signal correction section according to the sixth embodiment of the present disclosure. The drawing is a diagram illustrating a configuration example of the identification signal correction section 290. Note that, in the drawing, the histogram selection section 270 and the histogram generation sections 240a and 240b are further described. As illustrated in the drawing, the identification signal correction section 290 includes switches 291a to 298a and switches 291b to 298b that select one of the identification signal A and the identification signal B. The switches 291a to 298a are connected to AND gates 271 corresponding to the histogram generation section 240a in the histogram selection section 270, respectively. The switches 291b to 298b are connected to AND gates 271 corresponding to the histogram generation section 240b in the histogram selection section 270, respectively.

Selection of the identification signal A and the identification signal B in the switches 291a to 298a and the switches 291b to 298b is controlled on the basis of the adjustment time code. In the drawing, the identification signal correction section 290 corresponding to “distance measurement #1” described in FIG. 26 is illustrated. In the identification signal correction section 290 of FIG. 30, the switches 291a to 298a select the identification signal A, and the switches 291b to 298b select the identification signal B.

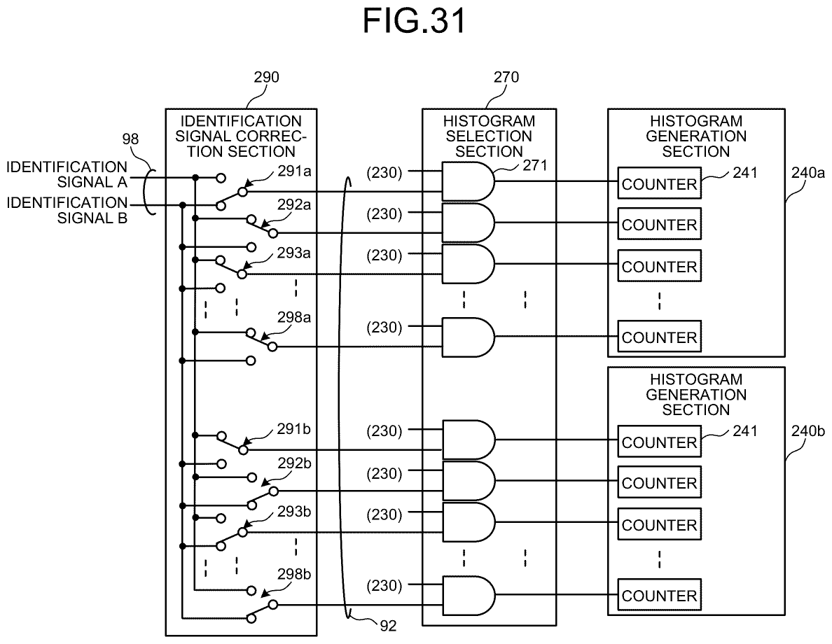

FIG. 31 is a diagram illustrating a configuration example of an identification signal correction section according to the sixth embodiment of the present disclosure. The drawing is a diagram illustrating a configuration example of the identification signal correction section 290 similarly to FIG. 30. The identification signal correction section 290 in the drawing represents a selection state of the switch 291a or the like corresponding to “distance measurement #2” described in FIG. 26. In FIG. 31, the switches 292a to 298a and 291b select the identification signal A, and the switches 292b to 298b and 291a select the identification signal B.

In this manner, the selection states of the identification signals A and B in the switches 291a to 298a and the switches 291b to 298b are sequentially switched according to the adjustment time code. Even in a case where the arrangement order of the time codes is changed by the adjustment, the converted time codes from the time code conversion section 230 can be distributed to the histogram generation sections 240a and 240b.

### [Generation of Histogram]

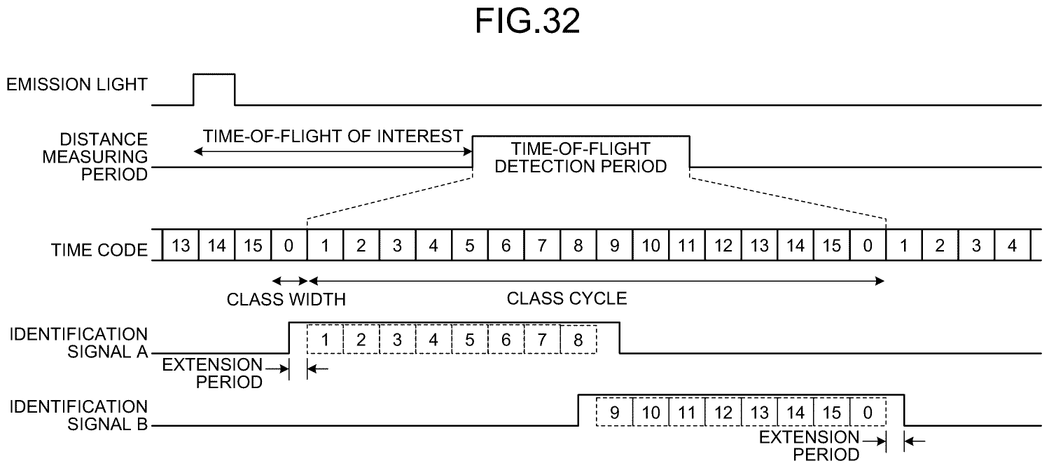

FIG. 32 is a diagram illustrating another example of the generation of the histogram according to the sixth embodiment of the present disclosure. Similarly to FIG. 23, the drawing is a timing chart illustrating an example of generation of a histogram of time-of-flights in the distance measuring section 40. In the drawing, “time code” represents an adjustment time code. Note that the time codes in the drawing represent time codes in an arrangement order corresponding to the adjustment time codes of “distance measurement #2” in FIG. 26. As illustrated in the drawing, the adjustment time code shifted by one class is output from the time code generation section 200.

Further, “identification signal A” and “identification signal B” in the drawing represent the waveforms of the identification signal A and the identification signal B corrected by the identification signal correction section 290. As illustrated in the drawing, the identification signal A is selected for the adjustment time codes “1” to “8”, and the identification signal B is selected for the adjustment time codes “9” to “0”. The identification signals A and B are corrected by such selection of the switch 291a and the like and input to the histogram selection section 270. Even in a case where the arrangement order of the time codes is shifted by the adjustment, the adjustment time code can be input to the counter 241 such as the histogram generation section 240a corresponding to each time code.

In FIG. 22, in the histogram selection section 270, the correspondence relationship between the first half and the second half time codes is determined by hardware, and cannot correspond to the adjustment time code. Therefore, the identification signal correction section 290 described with reference to FIGS. 30 and 31 is arranged, and the identification signal input to the AND gate 271 of the histogram selection section 270 is adjusted according to the adjustment time code.

As a result, it is possible to prevent the occurrence of inconsistency in selection of the histogram by the histogram selection section 270.

Note that the histogram selection section 270 and the identification signal correction section 290 are examples of a second histogram selection section described in the claims.

The configuration of the distance measuring device 1 other than this is similar to the configuration of the distance measuring device 1 according to the third embodiment of the present disclosure, and thus the description thereof will be omitted.

As described above, the distance measuring device 1 according to the sixth embodiment of the present disclosure adjusts the time codes to sequentially shift the positions of the classes of the histogram in the time-of-flight detection period to generate the histogram. As a result, the influence of the error such as the class width for each class is averaged, and the error of the histogram of the time-of-flight can be reduced.

### 7. Configuration of Reflected Light Signal Generation Section

Another example of the reflected light signal generation section described in the first embodiment of the present disclosure will be described.

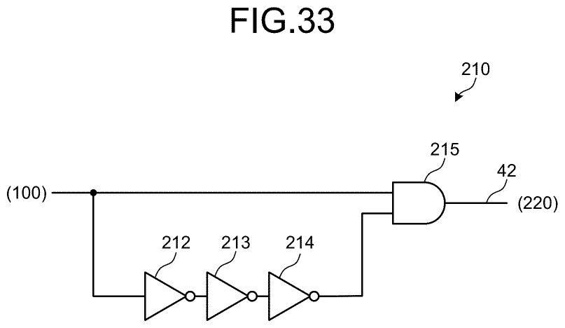

FIG. 33 is a diagram illustrating another configuration example of the reflected light signal generation section according to an embodiment of the present disclosure. The drawing is a circuit diagram illustrating a configuration example of the reflected light signal generation section 210 similarly to FIG. 4. The reflected light signal generation section 210 in the drawing includes a two-input AND gate 215 and NOT gates 212 to 214. The NOT gates 212 to 214 are sequentially connected in series. An output node of the pixel 100 is connected to an input of the NOT gate 212 and an input of the AND gate 215. The output of the NOT gate 214 is connected to another input of the AND gate 215. The output of the AND gate 215 is connected to the signal line 42.

The drawing constitutes a so-called rising differential circuit. In the drawing, the circuits of the NOT gates 212 to 214 connected in series constitute a signal delay section. When a light reception signal is input from the pixel 100, a reflected light signal having a pulse width corresponding to the delay time of the circuits of the NOT gates 212 to 214 is output to the signal line 42.

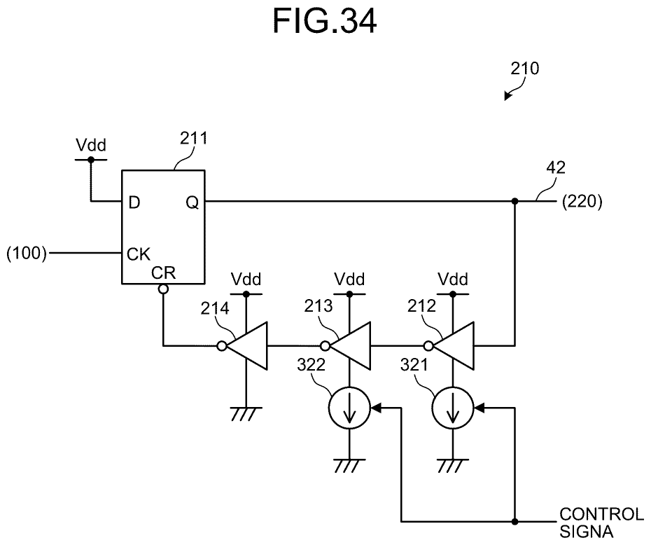

FIG. 34 is a diagram illustrating another configuration example of the reflected light signal generation section according to an embodiment of the present disclosure. The drawing is a circuit diagram illustrating a configuration example of the reflected light signal generation section 210 similarly to FIG. 4. The reflected light signal generation section 210 in the drawing is different from the reflected light signal generation section 210 in FIG. 4 in further including constant current circuits 321 and 322.

In the drawing, the ground terminal of the NOT gate 212 is grounded via the constant current circuit 321. The ground terminal of the NOT gate 213 is grounded via the constant current circuit 322. A control signal is commonly input to the control inputs of the constant current circuits 321 and 322.

The constant current circuits 321 and 322 are constant current circuits that adjust the current flowing therethrough according to a control signal. By connecting the constant current circuits 321 and 322 in series to the ground terminal of the NOT gate 212 and the ground terminal of the NOT gate 213, the power supply current of the NOT gates 212 and 213 can be adjusted. As a result, the delay time of the NOT gates 212 and 213 constituting the signal delay section can be adjusted. The reflected light signal generation section 210 in the drawing can adjust the pulse width of the reflected light signal by changing the control signal. Note that the circuits of the constant current circuits 321 and 322 are an example of a delay time adjustment section described in the claims.

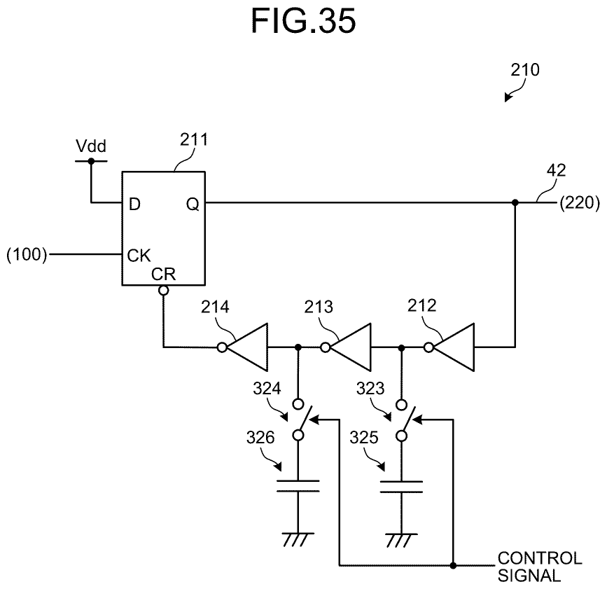

FIG. 35 is a diagram illustrating another configuration example of the reflected light signal generation section according to an embodiment of the present disclosure. The drawing is a circuit diagram illustrating a configuration example of the reflected light signal generation section 210 similarly to FIG. 4. The reflected light signal generation section 210 in the drawing is different from the reflected light signal generation section 210 in FIG. 4 in further including switch elements 323 and 324 and capacitors 325 and 326.

In the drawing, the switch element 323 and the capacitor 325 connected in series are connected between the output of the NOT gate 212 and the ground line. In addition, the switch element 324 and the capacitor 326 connected in series are connected between the output of the NOT gate 212 and the ground line. A control signal is commonly input to control inputs of the switch elements 323 and 324.

The switch element 323 is an element that opens and closes between the output of the NOT gate 212 and the capacitor 325. The switch element 324 opens and closes between the output of the NOT gate 213 and the capacitor 326. When the capacitor 325 or the like is connected to the output of the NOT gate 212 or the like, the rising and falling times of the output of the NOT gate 212 or the like can be delayed. As a result, the delay time of the NOT gates 212 and 213 constituting the signal delay section can be adjusted. The reflected light signal generation section 210 in the drawing can adjust the pulse width of the reflected light signal by inputting the control signal and conducting the switch elements 323 and 324.

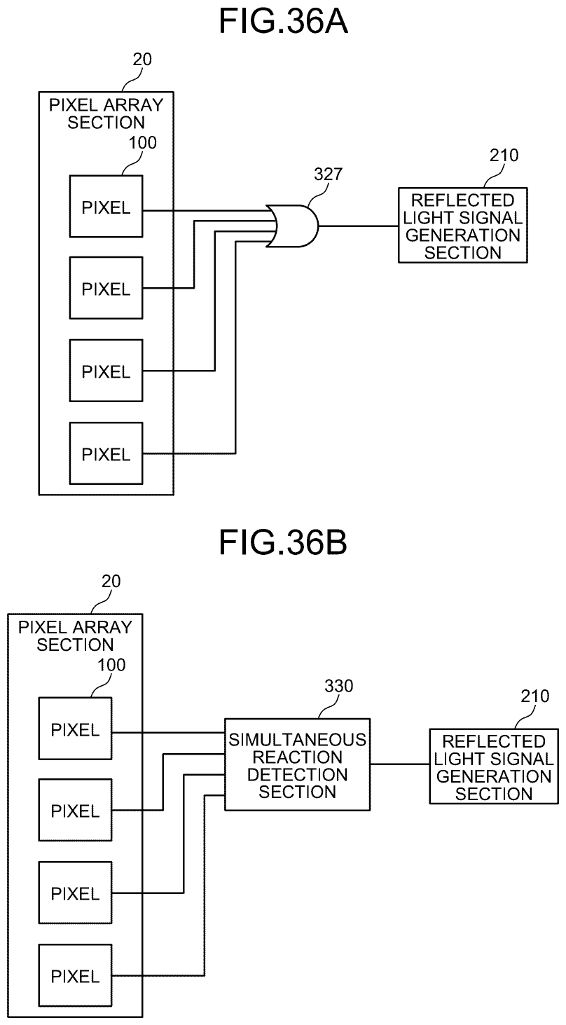

FIGS. 36A and 36B are diagrams illustrating another configuration example of the pixel array section and the reflected light signal generation section according to an embodiment of the present disclosure. The drawing is a diagram illustrating an example of a case where the light reception signals of a plurality of pixels 100 are aggregated and input to the reflected light signal generation section 210.

FIG. 36A illustrates an example of a case where the reflected light signal is generated on the basis of the logical sum of the light reception signals of the plurality of pixels 100. An OR gate 327 in the drawing is a gate that generates a signal of the logical sum of the light reception signals of the plurality of pixels 100 and outputs the signal to the reflected light signal generation section 210.

FIG. 36B illustrates an example of a case where the reflected light signal is generated when light reception signals are simultaneously output from the plurality of pixels 100. A simultaneous reflection detection section 330 in the drawing detects whether the plurality of pixels 100 has reacted simultaneously. Specifically, when the light reception signals are simultaneously output from the plurality of pixels 100, the simultaneous reflection detection section 330 outputs the detection signal to the reflected light signal generation section 210.

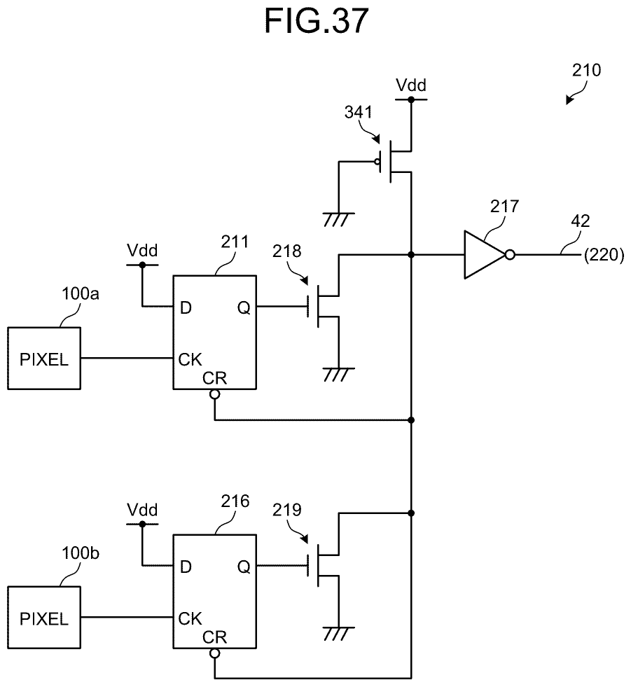

FIG. 37 is a diagram illustrating another configuration example of the reflected light signal generation section according to an embodiment of the present disclosure. The drawing illustrates an example of a case where the light reception signals of the plurality of pixels 100 are input to the reflected light signal generation section 210. The reflected light signal generation section 210 generates the reflected light signal on the basis of the logical sum of the plurality of light reception signals. Note that the drawing illustrates an example of a case where the pixels 100a and 100b are connected.

The reflected light signal generation section 210 in the drawing includes D flip-flops 211 and 216, a NOT gate 217, and MOS transistors 218, 219, and 341. As the MOS transistors 218 and 219, n-channel MOS transistors can be used. As the MOS transistor 341, a p-channel MOS transistor can be used.

The data input terminals of the D flip-flops 211 and 216 are connected to a power supply line Vdd. The output of the pixel 100a is connected to a clock input terminal of the D flip-flop 211. The Q output of the D flip-flop 211 is connected to the gate of the MOS transistor 218. The source of the MOS transistor 218 is grounded. The drain of the MOS transistor 218 is connected to the clear terminal of the D flip-flop 211, the drain of the MOS transistor 341, the input of the NOT gate 217, the drain of the MOS transistor 219, and the clear terminal of the D flip-flop 216.

The output of the pixel 100b is connected to a clock input terminal of the D flip-flop 216. The Q output of the D flip-flop 216 is connected to the gate of the MOS transistor 218. The source of the MOS transistor 218 is grounded. The source of the MOS transistor 341 is connected to the power supply line Vdd, and the gate is grounded. The output of the NOT gate 217 is connected to the signal line 42.

The MOS transistor 341 is a MOS transistor that supplies a power supply voltage to the input node of the NOT gate 217. The MOS transistor 341 charges the input node of the NOT gate 217 to the power supply voltage.

When the light reception signal from the pixel 100a is input to the data input terminal of the D flip-flop 211, the Q output of the D flip-flop 211 becomes the value “1”, and the MOS transistor 218 is conducted. Then, the input node of the NOT gate 217 is discharged and becomes the value “0”. Since this value “O” is input to the clear terminal, the Q output of the D flip-flop 211 returns to the value “0”. As described above, the circuit of the D flip-flop 211 detects the rising of the light reception signal of the pixel 100a and generates the reflected light signal.

The circuits of the pixel 100b and the D flip-flop 216 operate similarly. Outputs of the MOS transistors 218 and 219 are connected by wired OR connection and input to the NOT gate 217. The NOT gate 217 outputs the reflected light signal converted into the positive logic to the signal line 42.

### 8. Configuration of Distance Measuring Device

An example of a configuration of a semiconductor chip according to a distance measuring device of an embodiment of the present disclosure will be described.

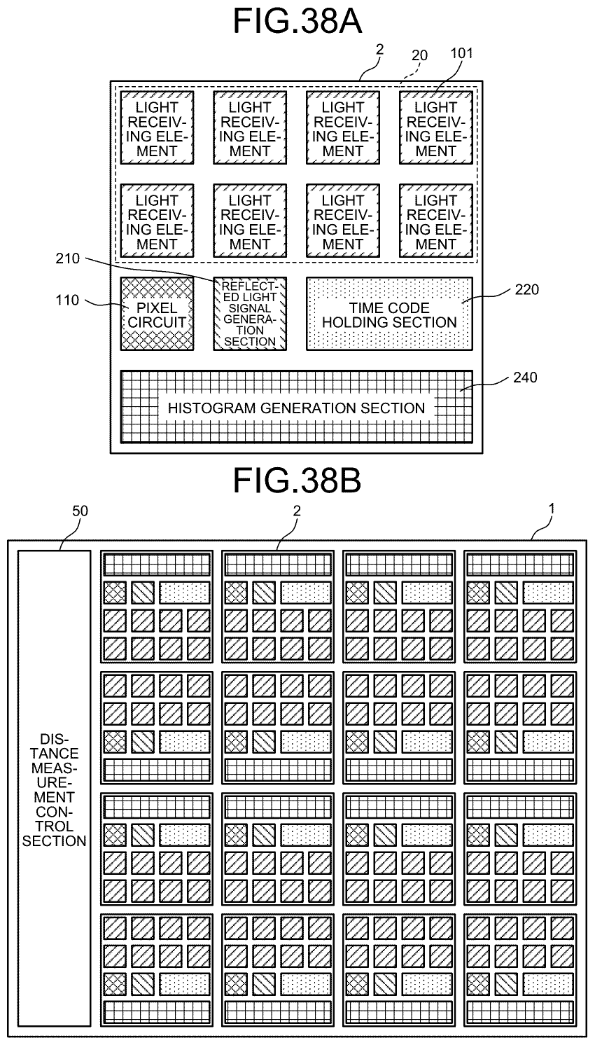

FIG. 38A is a plan view illustrating a configuration example of a light detection element according to an embodiment of the present disclosure. The drawing is a plan view illustrating a configuration example of the light detection element 2. The drawing is a diagram illustrating an example of a semiconductor chip constituting the light detection element 2. The pixel array section 20 is arranged on the upper side of the light detection element 2 in the drawing. A plurality of light receiving elements 101 is arranged in the pixel array section 20 in the drawing. The drawing illustrates an example in which eight light receiving elements 101 are arranged. A pixel circuit 110, the reflected light signal generation section 210, and the time code holding section 220 are arranged below the pixel array section 20. The histogram generation section 240 is arranged below the pixel circuits 110 and the like. Note that the pixel circuit 110 includes a circuit excluding the light receiving element 101 in FIG. 3. Furthermore, the pixel circuit 110 can further include a circuit that aggregates a plurality of light reception signals.

FIG. 38B is a plan view illustrating a configuration example of a distance measuring device according to an embodiment of the present disclosure. The drawing is a plan view illustrating a configuration example of the distance measuring device 1, and is a diagram illustrating an example of a semiconductor chip constituting the distance measuring device 1. A plurality of light detection elements 2 in FIG. 38A is arranged in the distance measuring device 1 in the drawing. The distance measurement control section 50 is arranged on the left side of the light detection element 2 in the drawing. The distance measuring device 1 in the drawing illustrates an example in which 16 light detection elements 2 are arranged.

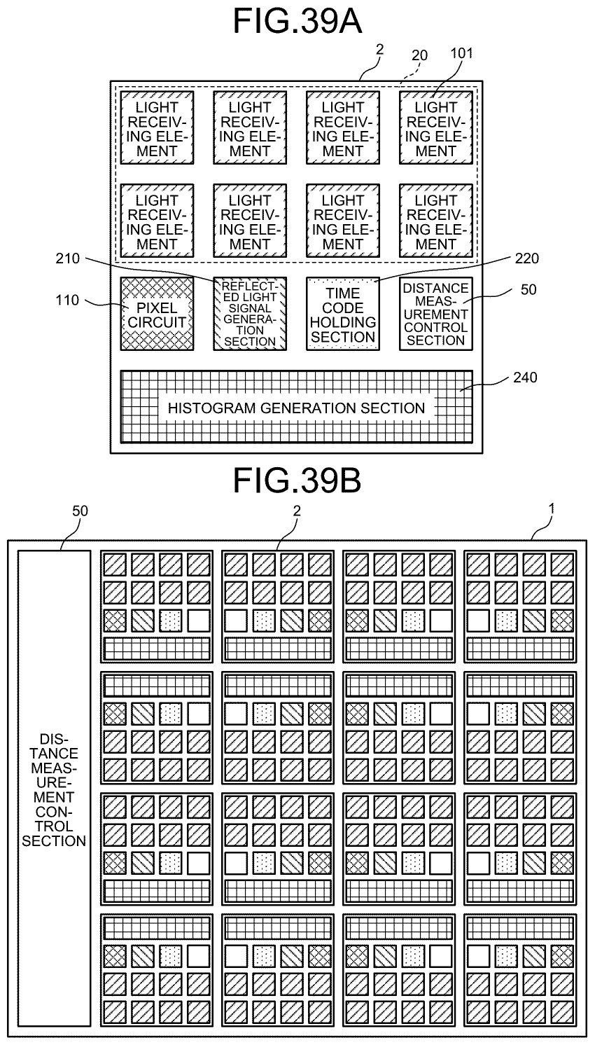

FIG. 39A is a plan view illustrating another example of the configuration of the light detection element according to an embodiment of the present disclosure. The drawing is a plan view illustrating a configuration example of the light detection element 2 similarly to FIG. 38A. In the light detection element 2 in the drawing, a part of the circuit constituting the distance measurement control section 50 is arranged adjacent to the time code holding section 220.

FIG. 39B is a plan view illustrating another example of the configuration of the distance measuring device according to an embodiment of the present disclosure. Similarly to FIG. 38B, the drawing is a plan view illustrating a configuration example of the distance measuring device 1, and is a view illustrating an example of a semiconductor chip constituting the distance measuring device 1. A plurality of light detection elements 2 in FIG. 39A is arranged in the distance measuring device 1 in the drawing. The distance measurement control section 50 is arranged on the left side of the light detection element 2 in the drawing. Note that, since a part of the distance measurement control section 50 is arranged in the light detection element 2, the distance measurement control section 50 in the drawing can reduce the size.

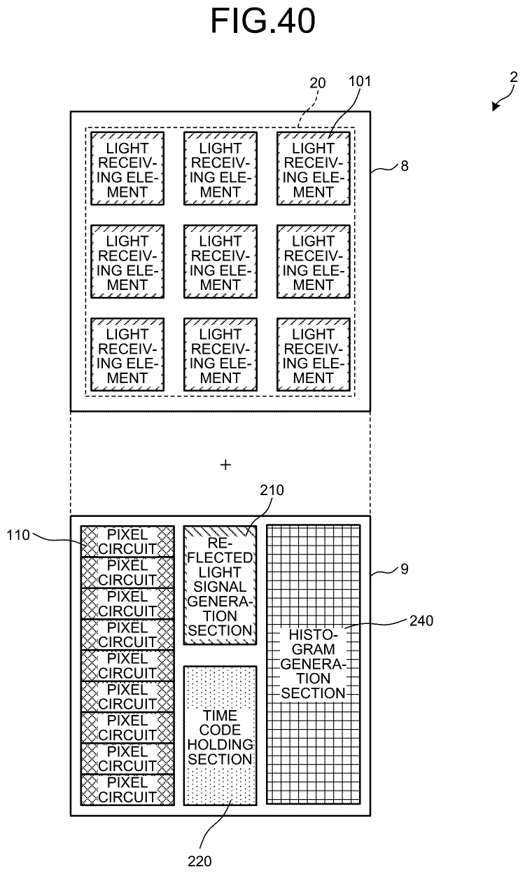

FIG. 40 is a plan view illustrating another example of the configuration of the light detection element according to an embodiment of the present disclosure. The drawing is a diagram illustrating a configuration example of the light detection element 2 similarly to FIG. 38A. The light detection element 2 in the drawing is different from the light detection element 2 in FIG. 38A in that a plurality of semiconductor wafers is stacked. The upper side of the drawing represents a light receiving element region 8, and the lower side of the drawing represents a logic circuit region 9. In the light receiving element region 8, a pixel array section 20 including a plurality of light receiving elements 101 is arranged. Furthermore, in the logic circuit region 9, a plurality of pixel circuits 110, a reflected light signal generation section 210, a time code holding section 220, and a histogram generation section 240 are arranged. The light receiving element region 8 and the logic circuit region 9 are stacked to form the light detection element 2.

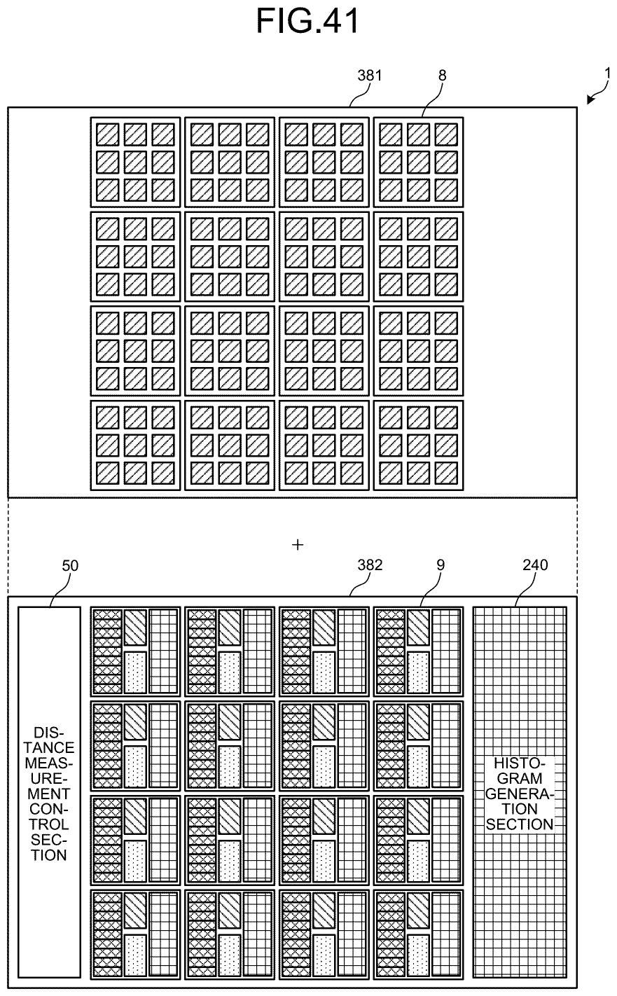

FIG. 41 is a plan view illustrating another example of the configuration of the distance measuring device according to an embodiment of the present disclosure. The drawing is a diagram illustrating a configuration example of the distance measuring device 1 similarly to FIG. 38B. The distance measuring device 1 in the drawing is different from the distance measuring device 1 in FIG. 38B in that a plurality of semiconductor chips (semiconductor wafers) is stacked. A plurality of light receiving element regions 8 of FIG. 40 is arranged on the semiconductor wafer 381 on the upper side of the drawing. A plurality of logic circuit regions 9 of FIG. 40 is arranged on the semiconductor wafer 382 on the lower side of the drawing. In addition, the histogram generation section 240 and the distance measurement control section 50 are further arranged on the semiconductor wafer 382 on the lower side of the drawing. These semiconductor wafers are stacked to configure the plurality of light detection elements 2 and configure the distance measuring device 1. Note that the semiconductor wafer 381 is an example of a first semiconductor chip described in the claims. The semiconductor wafer 382 is an example of a second semiconductor chip described in the claims.

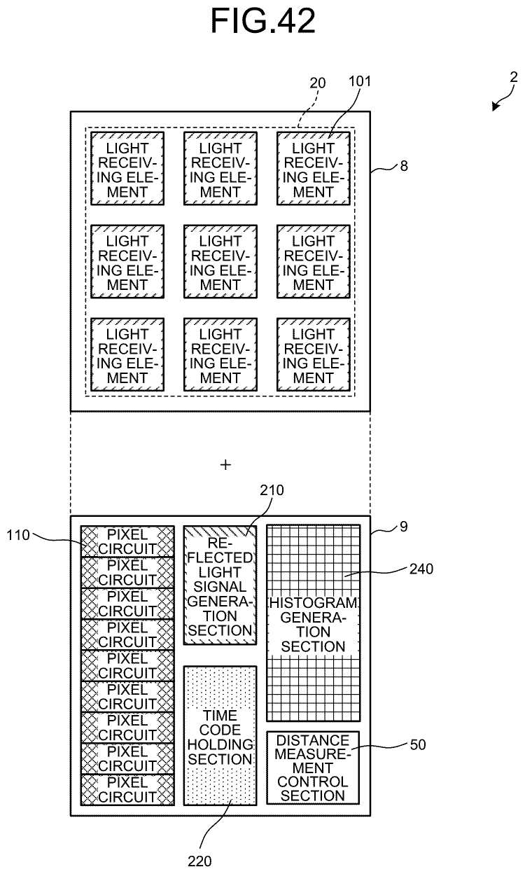

FIG. 42 is a plan view illustrating another example of the configuration of the light detection element according to an embodiment of the present disclosure. The drawing is a diagram illustrating a configuration example of the light detection element 2 similarly to FIG. 40. The light detection element 2 in the drawing is different from the light detection element 2 in FIG. 40 in that a part of the circuit of the distance measurement control section 50 is arranged in the logic circuit region 9.

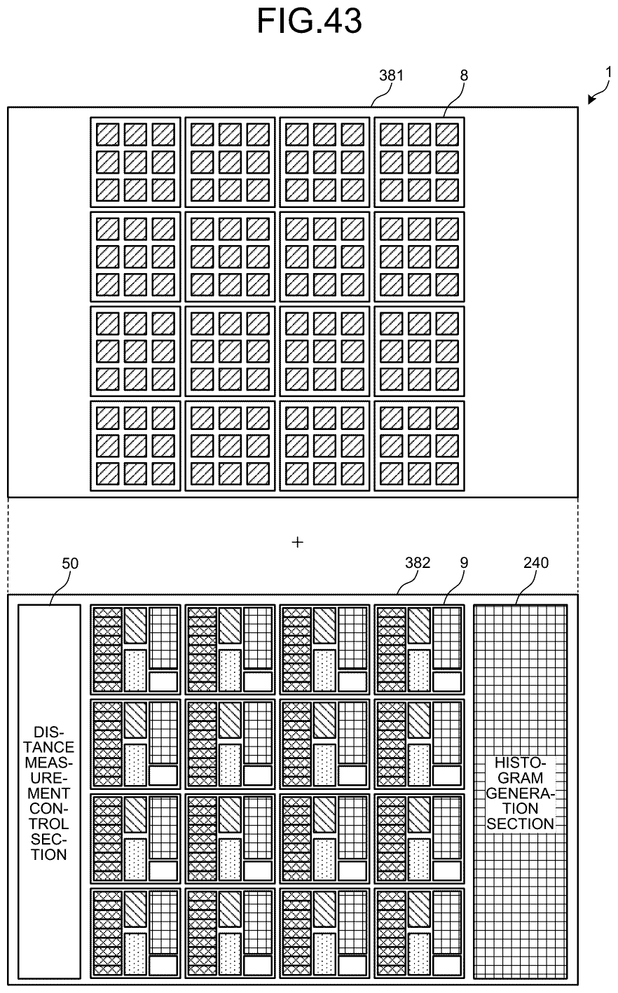

FIG. 43 is a plan view illustrating another example of the configuration of the distance measuring device according to an embodiment of the present disclosure. The drawing is a diagram illustrating a configuration example of the distance measuring device 1 similarly to FIG. 41. A plurality of light receiving element regions 8 of FIG. 42 is arranged on the semiconductor wafer 381 on the upper side of the drawing. A plurality of logic circuit regions 9 of FIG. 42 is arranged on the semiconductor wafer 382 on the lower side of the drawing. In addition, the histogram generation section 240 and the distance measurement control section 50 are further arranged on the semiconductor wafer 382 on the lower side of the drawing. These semiconductor wafers are stacked to configure the plurality of light detection elements 2 and configure the distance measuring device 1. Note that since a part of the distance measurement control section 50 is arranged in the logic circuit region 9, the distance measurement control section 50 in the drawing can reduce the size.

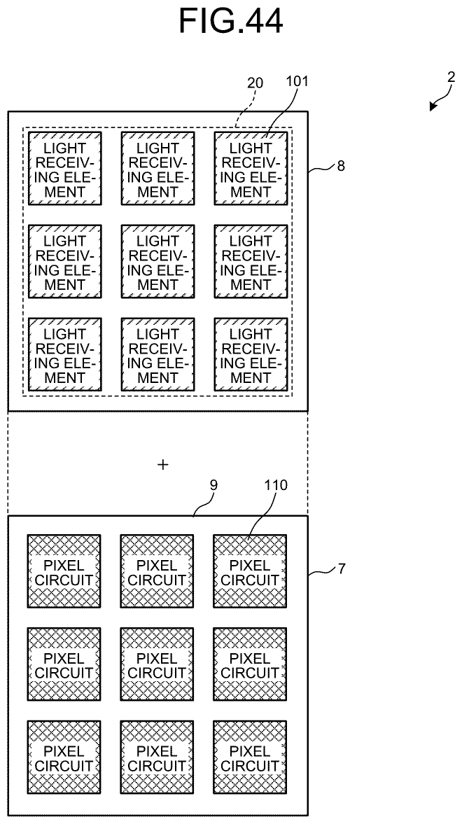

FIG. 44 is a plan view illustrating another example of the configuration of the light detection element according to an embodiment of the present disclosure. The drawing is a diagram illustrating a configuration example of the light detection element 2 similarly to FIG. 40. The light detection element 2 is different from the light detection element 2 of FIG. 40 in that a pixel circuit region 7 including a plurality of pixel circuits 110 is arranged on the semiconductor wafer 382 on the lower side of the drawing.

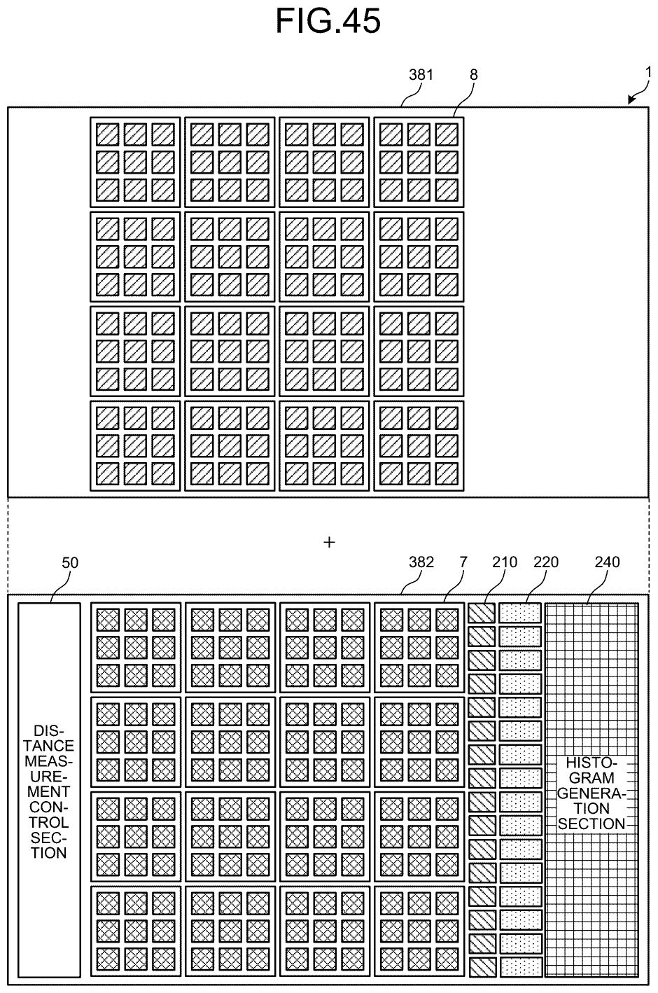

FIG. 45 is a plan view illustrating another example of the configuration of the distance measuring device according to an embodiment of the present disclosure. The drawing is a diagram illustrating a configuration example of the distance measuring device 1 similarly to FIG. 41. A plurality of light receiving element regions 8 of FIG. 44 is arranged on the semiconductor wafer 381 on the upper side of the drawing. A plurality of pixel circuit regions 7 of FIG. 42 is arranged on the semiconductor wafer 382 on the lower side of the drawing. In addition, the reflected light signal generation section 210, the time code holding section 220, the histogram generation section 240, and the distance measurement control section 50 are further arranged on the semiconductor wafer 382 on the lower side of the drawing. These semiconductor wafers are stacked to configure the plurality of light detection elements 2 and configure the distance measuring device 1. In the distance measuring device 1 in the drawing, since the pixel circuit region 7 having a relatively small area is arranged immediately below the light receiving element region 8, the small light receiving element 101 can be adopted. The spatial resolution in distance measurement can be improved.

### 9. Application Example to Mobile Body

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

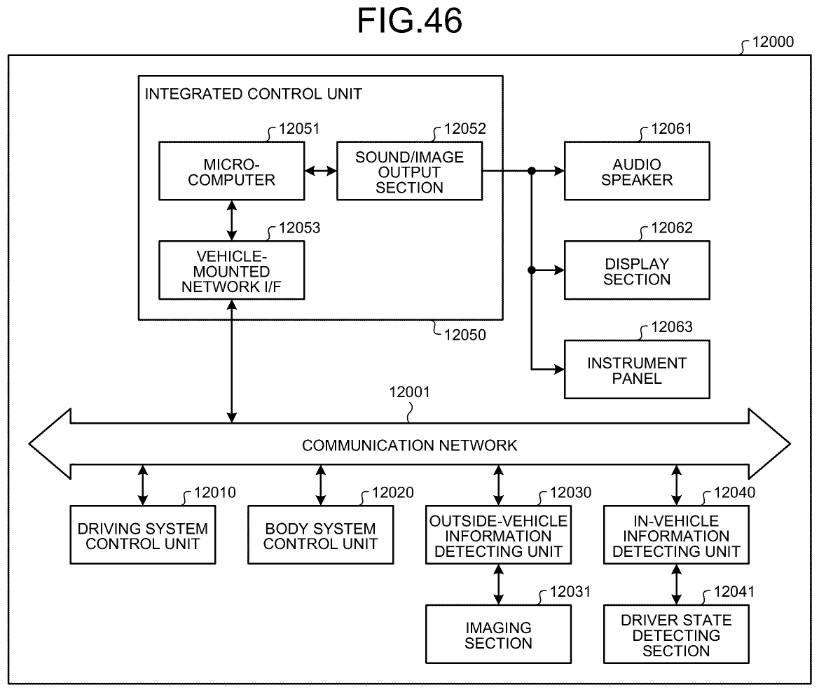

FIG. 46 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 46, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 46, an audio speaker 12061, a display section 12062, and an instrument panel 12063 are illustrated as the output device. The display section 12062 may, for example, include at least one of an on-board display and a head-up display.

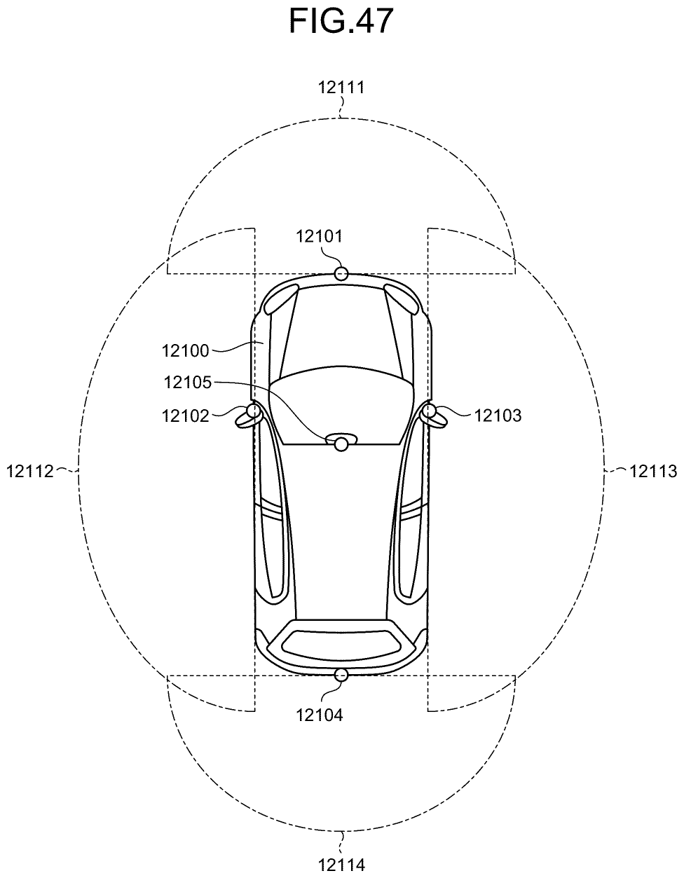

FIG. 47 is a diagram depicting an example of the installation position of the imaging section 12031.

In FIG. 47, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of a vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 47 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above. Specifically, the light detection element 2 in FIG. 1 can be applied to the imaging section 12031.

### Effects

The light detection element 2 includes a pixel 100, a reflected light signal generation section 210, a time code generation section 200, and a time code holding section 220. The pixel 100 includes a light receiving element 101 that receives reflected light obtained by reflecting the emission light emitted from the light emitting element 10 by the target object, and generates a light reception signal based on the reception of the reflected light. The reflected light signal generation section 210 generates a reflected light signal that is a signal having a predetermined pulse width on the basis of the light reception signal. The time code generation section 200 generates a time code that is a time-series code according to the elapsed time from the emission of the emission light for each specific cycle. The time code holding section 220 includes a latch circuit that has a data input terminal to which the generated time code is input and an enable terminal to which the reflected light signal is input and holds the input time code, outputs the time code input during a period in which the reflected light signal is input from the output terminal, and holds the input time code when the input of the reflected light signal is stopped. By using the latch circuit, power consumption can be reduced.

Furthermore, the light receiving element 101 may include an avalanche photo diode. Thus, the reflected light can be detected at high speed.

In addition, a histogram generation section 240 may be further included that creates a histogram representing the detection frequency of the time-of-flight from the emission of the emission light to the reception of the reflected light as a frequency for each class of the width of the specific cycle on the basis of the held time code. This makes it possible to detect the distribution of the time-of-flight.

In addition, the histogram generation section 240 may include a plurality of counters 241 corresponding to each of the classes, and generate the histogram by updating the count value of the counter 241 corresponding to the classes according to the held time code.

Furthermore, the reflected light signal generation section 210 may include a signal delay section that delays the light reception signal, and generate a reflected light signal having a pulse width corresponding to the delay time of the signal delay section. As a result, a reflected light signal having a desired pulse width can be generated.

Furthermore, the reflected light signal generation section 210 may further include a delay time adjustment section that adjusts the delay time of the signal delay section. Thus, the pulse width of the reflected light signal can be adjusted.

Furthermore, the plurality of pixels 100 may be included, and the reflected light signal generation section 210 may generate the reflected light signal on the basis of the result of the logical sum calculation of the light reception signals of the plurality of pixels 100. As a result, the light reception signals of the plurality of pixels 100 can be aggregated to generate the reflected light signal.

Furthermore, the plurality of pixels 100 may be included, and the reflected light signal generation section 210 may generate the reflected light signal when a predetermined number of light reception signals are generated by the plurality of pixels 100 within a certain period. As a result, it is possible to prevent generation of a reflected light signal due to a malfunction of the pixel 100.

Furthermore, the time code generation section 200 may generate a time code including a binary code.

Furthermore, the time code generation section 200 may generate a time code including a gray code. As a result, the influence of the time shift for each bit in the time code can be reduced.

Furthermore, a time code conversion section that converts a time code into a one-hot code representing a class to which the time code corresponds may be further included, and the histogram generation section 240 may generate a histogram on the basis of the one-hot code. As a result, it is possible to easily generate the count signal of the counter constituting the histogram generation section.

In addition, the first semiconductor chip (semiconductor wafer 381) including the pixel 100 and the second semiconductor chip (semiconductor wafer 382) including the reflected light signal generation section 210, the time code generation section 200, and the time code holding section 220 and stacked on the first semiconductor chip (semiconductor wafer 381) may be included. As a result, the light detection element can be downsized.

The light detection element 2 includes a pixel 100, a reflected light signal generation section 210, a time code generation section 200, a plurality of time code holding sections 220, a control section 250, and a histogram generation section 240. The pixel 100 includes a light receiving element 101 that receives reflected light obtained by reflecting the emission light emitted from the light emitting element 10 by the target object, and generates a light reception signal based on the reception of the reflected light. The reflected light signal generation section 210 generates a reflected light signal that is a signal having a predetermined pulse width on the basis of the light reception signal. The time code generation section 200 generates a time code that is a time-series code according to the elapsed time from the emission of the emission light for each specific cycle. The time code holding section 220 holds a time code when the reflected light signal is generated. The control section 250 performs control to exclusively select the plurality of time code holding sections 220 according to the generation of the reflected light signal and causes the selected time code holding section 220 to hold the time code. The histogram generation section 240 generates a histogram representing the detection frequency of the time-of-flight from the emission of the emission light to the reception of the reflected light as a frequency for each class of the width of the specific cycle on the basis of the time code held in the time code holding section 220. As a result, it is possible to cope with a short specific cycle.

Furthermore, the control section 250 may further perform control to cause the histogram generation section 240 to output the time code held in the time code holding section 220 different from the selected time code holding section 220 according to the generation of the reflected light signal, and the histogram generation section 240 may generate the histogram on the basis of the output time code. As a result, it is possible to simultaneously hold the time code in the time code holding section and update the histogram with the held time code, and it is possible to generate the histogram at high speed.

In addition, the histogram generation section 240 includes a plurality of counters 241 corresponding to each class, and generates a histogram by updating the count value of the counter 241 corresponding to the class according to the held time code, and the control section 250 can further control the update in the counter 241 of the histogram generation section 240.

The light detection element 2 includes a pixel 100, a reflected light signal generation section 210, a time code generation section 200, a time code holding section 220, and a plurality of histogram generation sections 240. The pixel 100 includes a light receiving element 101 that receives reflected light obtained by reflecting the emission light emitted from the light emitting element 10 by the target object, and generates a light reception signal based on the reception of the reflected light. The reflected light signal generation section 210 generates a reflected light signal that is a signal having a predetermined pulse width on the basis of the light reception signal. The time code generation section 200 generates and outputs a time code, which is a time-series code according to the elapsed time from the emission of the emission light, for each specific cycle. The time code holding section 220 holds a time code when the reflected light signal is generated. The histogram generation section 240 generates a histogram representing the detection frequency of the time-of-flight from the emission of the emission light to the reception of the reflected light as a frequency for each class of the width of the specific cycle on the basis of the held time code. The time code generation section 200 divides the time code into a plurality of time code groups, and further outputs an identification signal representing a range of a time-of-flight to be subjected to histogram generation and identifying a time code group of the time code output in a time-of-flight detection period in units of a specific cycle, the time code holding section 220 further holds the identification signal when the reflected light signal is generated, the histogram generation section 240 generates its own histogram in a case where the time code and the identification signal that are arranged for each time code group and held in the time code holding section 220 are a time code and an identification signal corresponding to its own time code group, and the time code generation section 200 generates the time code by switching the time code group at an initial stage and an end stage of the time-of-flight detection period, and generates and outputs an identification signal obtained by extending a period of a time code group related to at least one of an initial period and an end period of a time-of-flight detection period. As a result, it is possible to reduce an error in the time-of-flight at an initial stage and an end stage of the time-of-flight detection period.

Further, a histogram selection section 260 that selects a plurality of histogram generation sections 240 according to the time code group and outputs the held time code may be further included. As a result, a histogram can be generated for each time code group.

In addition, the plurality of time code groups may be a time code group including odd-numbered time codes and a time code group including even-numbered time codes.

In addition, the plurality of time code groups may be time code groups configured by dividing time-series time codes into a plurality of periods.

In addition, the histogram generation section 240 may include a plurality of counters 241 corresponding to each class for each time code group, and may generate a histogram by updating the count value of the counter 241 corresponding to the class according to the held time code.

In addition, a plurality of time code holding sections 220 that sequentially holds the time code and the identification signal may be included, and the histogram generation section 240 may generate the histogram on the basis of the time code and the identification signal held by the plurality of time code holding sections 220. As a result, it is possible to cope with a short specific cycle.

In addition, the histogram generation section 240 may generate the histogram according to the time code based on the reflected light signal generated on the basis of the emission light emitted from the light emitting element 10 in synchronization with the distance measuring period repeated in a predetermined cycle. As a result, the distance measurement range can be limited.

In addition, the time code generation section 200 may adjust the time code corresponding to the time-of-flight detection period for each distance measuring period and generate an adjustment identification signal that is an identification signal corresponding to an adjustment time code that is an adjustment time code, and the histogram generation section 240 may generate a histogram on the basis of the adjustment time code and the adjustment identification signal. As a result, it is possible to level the error for each class of the histogram.

Furthermore, the time code generation section 200 may adjust the time code by shifting the initial value of the time-series time code.

In addition, a histogram correction section 280 that corrects a histogram generated for each distance measuring period may be further included. The shift of the class of the histogram due to the adjustment of the time codes can be corrected.

In addition, a second histogram selection section (histogram selection section 270 and identification signal correction section 290) that selects a plurality of histogram generation sections 240 according to the time code group and the adjustment identification signal and outputs the held time code may be further included. As a result, it is possible to prevent the occurrence of inconsistency in selection of the histogram due to adjustment of the time codes.

Note that the effects described in the present specification are merely examples and are not limited, and other effects may be provided.

Note that the present technology can also have the following configurations.

(1)

A light detection element comprising:
a pixel including a light receiving element that receives reflected light obtained by reflecting emission light emitted from a light source device by a target object, and generates a light reception signal based on reception of the reflected light;
a reflected light signal generation section that generates a reflected light signal that is a signal having a predetermined pulse width on the basis of the light reception signal;
a time code generation section that generates a time code that is a time-series code according to an elapsed time from emission of the emission light for each specific cycle; and
a time code holding section that includes a latch circuit that has a data input terminal to which the time code generated is input and an enable terminal to which the reflected light signal is input and holds the time code input, outputs the time code input from an output terminal during a period in which the reflected light signal is input, and holds the time code input when input of the reflected light signal is stopped.
   (2)

The light detection element according to the above (1), wherein
the light receiving element includes an avalanche photo diode.
   (3)

The light detection element according to the above (1) or (2), further comprising
a histogram generation section that generates a histogram representing a detection frequency of a time-of-flight from emission of the emission light to reception of the reflected light as a frequency for each class of a width of the specific cycle on the basis of the time code held.
   (4)

The light detection element according to the above (3), wherein
the histogram generation section includes a plurality of counters corresponding to each class, and generates the histogram by updating a count value of the counter corresponding to the class according to the time code held.
   (5)

The light detection element according to any one of the above (1) to (5), wherein
the reflected light signal generation section includes a signal delay section that delays the light reception signal, and generates the reflected light signal having a pulse width corresponding to a delay time of the signal delay section.
   (6)

The light detection element according to the above (5), wherein
the reflected light signal generation section further includes a delay time adjustment section that adjusts a delay time of the signal delay section.
   (7)

The light detection element according to any one of the above (1) to (6), further comprising
a plurality of the pixel, wherein
the reflected light signal generation section generates the reflected light signal on the basis of a result of a logical sum calculation of light reception signals of the plurality of the pixel.
   (8)

The light detection element according to any one of the above (1) to (6), further comprising
a plurality of the pixel, wherein
the reflected light signal generation section generates the reflected light signal when a predetermined number of the light reception signal is generated by the plurality of the pixel within a certain period.
   (9)

The light detection element according to any one of the above (1) to (8), wherein
the time code generation section generates the time code including a binary code.
   (10)

The light detection element according to any one of the above (1) to (8), wherein
the time code generation section generates the time code including a gray code.
   (11)

The light detection element according to any one of the above (3) to (10), further comprising
a time code conversion section that converts the time code into a one-hot code representing the class corresponding to the time code, wherein
the histogram generation section generates the histogram on the basis of the one-hot code.
   (12)

The light detection element according to any one of the above (1) to (11), further comprising:
a first semiconductor chip including the pixel; and
a second semiconductor chip including the reflected light signal generation section, the time code generation section, and the time code holding section, the second semiconductor chip being stacked on the first semiconductor chip.
   (13)

A light detection element comprising:
a pixel including a light receiving element that receives reflected light obtained by reflecting emission light emitted from a light source device by a target object, and generates a light reception signal based on reception of the reflected light;
a reflected light signal generation section that generates a reflected light signal that is a signal having a predetermined pulse width on the basis of the light reception signal;
a time code generation section that generates a time code that is a time-series code according to an elapsed time from emission of the emission light for each specific cycle;
a plurality of time code holding sections that holds the time code when the reflected light signal is generated;
a control section that performs control to exclusively select the plurality of time code holding sections according to generation of the reflected light signal and cause a selected time code holding section to hold the time code; and
a histogram generation section that generates a histogram representing a detection frequency of a time-of-flight from emission of the emission light to reception of the reflected light as a frequency for each class of a width of the specific cycle on the basis of the time code held in the time code holding section.
   (14)

The light detection element according to the above (13), wherein
the control section further performs control to cause the histogram generation section to output the time code held in the time code holding section different from the selected time code holding section according to generation of the reflected light signal, and
the histogram generation section generates the histogram on the basis of the time code output.
   (15)

The light detection element according to the above (13) or (14), wherein
the histogram generation section includes a plurality of counters corresponding to each class, and generates the histogram by updating a count value of the counter corresponding to the class according to the time code held, and the control section further controls update in the counter of the histogram generation section.
   (16)

A light detection element comprising:
a pixel including a light receiving element that receives reflected light obtained by reflecting emission light emitted from a light source device by a target object, and generates a light reception signal based on reception of the reflected light;
a reflected light signal generation section that generates a reflected light signal that is a signal having a predetermined pulse width on the basis of the light reception signal;
a time code generation section that generates and outputs a time code that is a time-series code according to an elapsed time from emission of the emission light in each specific cycle;
a time code holding section that holds the time code when the reflected light signal is generated; and
a plurality of histogram generation sections that generates a histogram representing a detection frequency of a time-of-flight from emission of the emission light to reception of the reflected light as a frequency for each class of a width of the specific cycle on the basis of the time code held, wherein
the time code generation section divides the time code into a plurality of time code groups, and further outputs an identification signal representing a range of the time-of-flight to be subjected to histogram generation and identifying a time code group of the time code to be output in a time-of-flight detection period in units of the specific cycle,
the time code holding section further holds the identification signal when the reflected light signal is generated,
the histogram generation section generates its own histogram in a case where the time code and the identification signal that are arranged for each time code group and held in the time code holding section are the time code and the identification signal corresponding to its own time code group, and
the time code generation section generates the time code by switching the time code group at an initial stage and an end stage of the time-of-flight detection period, and generates and outputs the identification signal obtained by extending a period of the time code group related to at least one of the initial stage and the end stage of the time-of-flight detection period.
   (17)

The light detection element according to the above (16) further comprising
a histogram selection section that selects the plurality of the histogram generation sections according to the time code group and outputs the time code held.
   (18)

The light detection element according to the above (16) or (17), wherein
the plurality of the time code groups is a time code group configured by an odd-numbered time code and a time code group configured by an even-numbered time code.
   (19)

The light detection element according to the above (16) or (17), wherein
the plurality of the time code groups is a time code group configured by dividing the time code in time series into a plurality of periods.
   (20)

The light detection element according to any one of the above (16) to (19), wherein
the histogram generation section includes a plurality of counters corresponding to each class for each time code group, and generates the histogram by updating a count value of the counter corresponding to the class according to the time code held.
   (21)

The light detection element according to any one of the above (16) to (20), further comprising
a plurality of the time code holding section that sequentially holds the time code and the identification signal, wherein
the histogram generation section generates the histogram on the basis of the time codes and the identification signals held by the plurality of the time code holding section.
   (22)

The light detection element according to any one of the above (16) to (21), wherein
the histogram generation section generates the histogram in accordance with the time code based on the reflected light signal generated on the basis of the emission light emitted from the light source device in synchronization with a distance measuring period repeated in a predetermined cycle.
   (23)

The light detection element according to the above (22), wherein
the time code generation section adjusts the time code corresponding to the time-of-flight detection period for each distance measuring period and generates an adjustment identification signal that is the identification signal according to an adjustment time code that is the time code adjusted, and
the histogram generation section generates the histogram on the basis of the adjustment time code and the adjustment identification signal.
   (24)

The light detection element according to the above (23), wherein
the time code generation section adjusts the time code by shifting an initial value of the time code in time series.
   (25)

The light detection element according to the above (23), further comprising
a histogram correction section that corrects a histogram generated for each distance measuring period.
   (26)

The light detection element according to tha above (23), further comprising
a second histogram selection section that selects the plurality of the histogram generation sections according to the time code group and the adjustment identification signal and outputs the time code held.

### REFERENCE SIGNS LIST

1 DISTANCE MEASURING DEVICE
2 LIGHT DETECTION ELEMENT
10 LIGHT EMITTING ELEMENT
20 PIXEL ARRAY SECTION
30 PIXEL DRIVE SECTION
40 DISTANCE MEASURING SECTION
50 DISTANCE MEASUREMENT CONTROL SECTION
100 PIXEL
101 LIGHT RECEIVING ELEMENT
200 TIME CODE GENERATION SECTION
210 REFLECTED LIGHT SIGNAL GENERATION SECTION
220, 220a, 220b, 220c, 220d TIME CODE HOLDING SECTION
221 to 226 D LATCH
230 TIME CODE CONVERSION SECTION
240, 240a, 240b HISTOGRAM GENERATION SECTION
241 COUNTER
250 CONTROL SECTION
260 TIME CODE SELECTION SECTION
270 HISTOGRAM SELECTION SECTION
280 HISTOGRAM CORRECTION SECTION
281 REARRANGEMENT SECTION
282 HISTOGRAM HOLDING SECTION
290 IDENTIFICATION SIGNAL CORRECTION SECTION
381, 382 SEMICONDUCTOR WAFER
390 SELECTION CONTROL SECTION
12101 to 12105 IMAGING SECTION

1. A light detection element comprising:
a pixel including a light receiving element that receives reflected light obtained by reflecting emission light emitted from a light source device by a target object, and generates a light reception signal based on reception of the reflected light;
a reflected light signal generation section that generates a reflected light signal that is a signal having a predetermined pulse width on the basis of the light reception signal;
a time code generation section that generates a time code that is a time-series code according to an elapsed time from emission of the emission light for each specific cycle; and
a time code holding section that includes a latch circuit that has a data input terminal to which the time code generated is input and an enable terminal to which the reflected light signal is input and holds the time code input, outputs the time code input from an output terminal during a period in which the reflected light signal is input, and holds the time code input when input of the reflected light signal is stopped.

2. The light detection element according to claim 1, wherein
the light receiving element includes an avalanche photo diode.

3. The light detection element according to claim 1, further comprising
a histogram generation section that generates a histogram representing a detection frequency of a time-of-flight from emission of the emission light to reception of the reflected light as a frequency for each class of a width of the specific cycle on the basis of the time code held.

4. The light detection element according to claim 3, wherein
the histogram generation section includes a plurality of counters corresponding to each class, and generates the histogram by updating a count value of the counter corresponding to the class according to the time code held.

5. The light detection element according to claim 1, wherein
the reflected light signal generation section includes a signal delay section that delays the light reception signal, and generates the reflected light signal having a pulse width corresponding to a delay time of the signal delay section.

6. The light detection element according to claim 5, wherein
the reflected light signal generation section further includes a delay time adjustment section that adjusts a delay time of the signal delay section.

7. The light detection element according to claim 1, further comprising
a plurality of the pixel, wherein
the reflected light signal generation section generates the reflected light signal on the basis of a result of a logical sum calculation of light reception signals of the plurality of the pixel.

8. The light detection element according to claim 1, further comprising
a plurality of the pixel, wherein
the reflected light signal generation section generates the reflected light signal when a predetermined number of the light reception signal is generated by the plurality of the pixel within a certain period.

9. The light detection element according to claim 1, wherein
the time code generation section generates the time code including a binary code.

10. The light detection element according to claim 1, wherein
the time code generation section generates the time code including a gray code.

11. The light detection element according to claim 3, further comprising
a time code conversion section that converts the time code into a one-hot code representing the class corresponding to the time code, wherein
the histogram generation section generates the histogram on the basis of the one-hot code.

12. The light detection element according to claim 1, further comprising:
a first semiconductor chip including the pixel; and
a second semiconductor chip including the reflected light signal generation section, the time code generation section, and the time code holding section, the second semiconductor chip being stacked on the first semiconductor chip.

13. A light detection element comprising:
a pixel including a light receiving element that receives reflected light obtained by reflecting emission light emitted from a light source device by a target object, and generates a light reception signal based on reception of the reflected light;
a reflected light signal generation section that generates a reflected light signal that is a signal having a predetermined pulse width on the basis of the light reception signal;
a time code generation section that generates a time code that is a time-series code according to an elapsed time from emission of the emission light for each specific cycle;
a plurality of time code holding sections that holds the time code when the reflected light signal is generated;
a control section that performs control to exclusively select the plurality of time code holding sections according to generation of the reflected light signal and cause a selected time code holding section to hold the time code; and
a histogram generation section that generates a histogram representing a detection frequency of a time-of-flight from emission of the emission light to reception of the reflected light as a frequency for each class of a width of the specific cycle on the basis of the time code held in the time code holding section.

14. The light detection element according to claim 13, wherein
the control section further performs control to cause the histogram generation section to output the time code held in the time code holding section different from the selected time code holding section according to generation of the reflected light signal, and
the histogram generation section generates the histogram on the basis of the time code output.

15. The light detection element according to claim 13, wherein
the histogram generation section includes a plurality of counters corresponding to each class, and generates the histogram by updating a count value of the counter corresponding to the class according to the time code held, and
the control section further controls update in the counter of the histogram generation section.

16. A light detection element comprising:
a pixel including a light receiving element that receives reflected light obtained by reflecting emission light emitted from a light source device by a target object, and generates a light reception signal based on reception of the reflected light;
a reflected light signal generation section that generates a reflected light signal that is a signal having a predetermined pulse width on the basis of the light reception signal;
a time code generation section that generates and outputs a time code that is a time-series code according to an elapsed time from emission of the emission light in each specific cycle;
a time code holding section that holds the time code when the reflected light signal is generated; and
a plurality of histogram generation sections that generates a histogram representing a detection frequency of a time-of-flight from emission of the emission light to reception of the reflected light as a frequency for each class of a width of the specific cycle on the basis of the time code held, wherein
the time code generation section divides the time code into a plurality of time code groups, and further outputs an identification signal representing a range of the time-of-flight to be subjected to histogram generation and identifying a time code group of the time code to be output in a time-of-flight detection period in units of the specific cycle,
the time code holding section further holds the identification signal when the reflected light signal is generated,
the histogram generation section generates its own histogram in a case where the time code and the identification signal that are arranged for each time code group and held in the time code holding section are the time code and the identification signal corresponding to its own time code group, and
the time code generation section generates the time code by switching the time code group at an initial stage and an end stage of the time-of-flight detection period, and generates and outputs the identification signal obtained by extending a period of the time code group related to at least one of the initial stage and the end stage of the time-of-flight detection period.

17. The light detection element according to claim 16, further comprising
a histogram selection section that selects the plurality of the histogram generation sections according to the time code group and outputs the time code held.

18. The light detection element according to claim 16, wherein
the plurality of the time code groups is a time code group configured by an odd-numbered time code and a time code group configured by an even-numbered time code.

19. The light detection element according to claim 16, wherein
the plurality of the time code groups is a time code group configured by dividing the time code in time series into a plurality of periods.

20. The light detection element according to claim 16, wherein
the histogram generation section includes a plurality of counters corresponding to each class for each time code group, and generates the histogram by updating a count value of the counter corresponding to the class according to the time code held.

21. The light detection element according to claim 16, further comprising
a plurality of the time code holding section that sequentially holds the time code and the identification signal, wherein
the histogram generation section generates the histogram on the basis of the time codes and the identification signals held by the plurality of the time code holding section.

22. The light detection element according to claim 16, wherein
the histogram generation section generates the histogram in accordance with the time code based on the reflected light signal generated on the basis of the emission light emitted from the light source device in synchronization with a distance measuring period repeated in a predetermined cycle.

23. The light detection element according to claim 22, wherein
the time code generation section adjusts the time code corresponding to the time-of-flight detection period for each distance measuring period and generates an adjustment identification signal that is the identification signal according to an adjustment time code that is the time code adjusted, and
the histogram generation section generates the histogram on the basis of the adjustment time code and the adjustment identification signal.

24. The light detection element according to claim 23, wherein
the time code generation section adjusts the time code by shifting an initial value of the time code in time series.

25. The light detection element according to claim 23, further comprising
a histogram correction section that corrects a histogram generated for each distance measuring period.

26. The light detection element according to claim 23, further comprising
a second histogram selection section that selects the plurality of the histogram generation sections according to the time code group and the adjustment identification signal and outputs the time code held.
